(19) United States
(12) Patent Application Publication
(10) Pub. No.: US 2026/0058506 A1
(43) Pub. Date: Feb. 26, 2026

(54) STATOR FOR AN ELECTRIC MOTOR AND METHODS FOR ASSEMBLING SAME

(71) Applicant: Indigo Technologies, Inc., Woburn, MA (US)

(72) Inventors: Jeremy Mayer, Mountain View, CA (US); Theophile Messin, Woburn, MA (US)

(73) Assignee: Indigo Technologies, Inc., Woburn, MA (US)

(21) Appl. No.: 19/316,020

(22) Filed: Sep. 2, 2025

Related U.S. Application Data
(63) Continuation of application No. PCT/US2024/018043, filed on Mar. 1, 2024.
(60) Provisional application No. 63/449,273, filed on Mar. 1, 2023.

(51) Int. Cl. H02K 1/14; H02K 1/18; H02K 3/28; H02K 3/34

(52) U.S. Cl. CPC H02K 1/146; H02K 1/182; H02K 3/28; H02K 3/345; H02K 2203/06; H02K 2203/12

(57) ABSTRACT

A stator for an electric motor, especially an axial flux motor, includes coils directly connected to one another, thus appreciably simplifying manufacturing and assembly by reducing or, in some instances, eliminating busbars from the stator and reducing the number of connection points to electrically connect the coils to an electrical power source. In one example, multiple coils may be formed from a single continuous conductor. In another example, multiple coils may be assembled from individually formed coils that are welded directly to one another. The stator may further include pole pieces with laminated structures to improve performance. A potting compound may also be applied to the stator in several ways, such as a trickle coating process or a transfer molding process.

### CROSS-REFERENCE TO RELATED APPLICATION(S)

This application is a bypass continuation of International Application No. PCT/US2024/018043, filed Mar. 1, 2024, which claims the priority benefit, under 35 U.S.C. 119(e), of U.S. Application No. 63/449,273, filed Mar. 1, 2023 and entitled, “STATOR STRUCTURES FOR AXIAL MOTORS,” which is incorporated herein by reference in its entirety.

### BACKGROUND

A radial flux motor is a type of electric motor commonly used for electric propulsion (e.g., electric vehicles, hybrid vehicles). Conventional radial flux motors typically include: (1) a rotor with multiple magnets positioned along the periphery of the rotor such that the magnetic flux lines generated by the magnets are oriented radially with respect to the rotation axis of the rotor; and (2) a stator, disposed circumferentially around the rotor, with multiple coil windings (also referred to herein as “coils”). When an electric current is supplied to the coils, the resultant interaction of the magnetic field of the coils and the permanent magnetic field of the magnets causes the rotor to rotate relative to the stator. Radial flux motors are often limited in terms of their efficiency, size, and torque output especially when compared to other electric motor topologies.

An axial flux motor, by comparison, may provide numerous advantages over conventional radial flux motors including a higher efficiency, a smaller size, a lower weight, and a higher torque output. Conventional axial flux motors typically include: (1) a rotor with multiple magnets disposed on a face of the rotor such that the magnetic flux lines generated by the magnets are parallel with the rotation axis of the rotor; and (2) a stator that is offset along the rotation axis of the rotor with multiple coils. Thus, the rotor and the stator in the axial flux motor often form a “pancake” or “flat” assembly where multiple rotors and/or stators are stacked onto one another along a common rotation axis. For example, FIG. 1A shows an example of a conventional axial flux motor 10 having a “flat cylinder” motor housing. The magnetic flux in the axial motor 10 travels axially through the pole pieces, i.e., parallel to the axis 11.

### SUMMARY

A stator in a conventional axial flux motor typically includes multiple subsets of coils to receive different electrical inputs. For example, a three-phase motor includes three separate electrical inputs corresponding to U, V, and W phases. Each subset of coils includes a complex arrangement of coils electrically connected together via numerous busbars. As a result, the assembly of a stator, especially the subsets of coils, is often a time-consuming and laborious process. Moreover, the stators typically include multiple electronic components, e.g., busbars, further increasing assembly costs.

For example, FIG. 1B shows a portion of an example stator in the axial flux motor 10 of FIG. 1A. As shown, the stator includes coils 14, 16, and 18 wound around respective pole pieces 12 (also referred to herein as “cores”). Generally, the coils 14, 16, and 18 are formed individually and separately connected to a busbar (not shown) at points 20, 22, and 24 respectively. The busbar is generally a solid and/or monolithic wiring plate or circuit board designed to facilitate electrical connections to the coils. The pole pieces 12 are typically solid bars formed from a soft magnetic composition (SMC) or a composite where SMC constitutes a large fraction of the composite. The pole pieces 12 are formed by pressing the SMC into a desired shape, e.g., a trapezoidal prism (see, for example, the pole pieces 12 in FIG. 1B) and thereafter sintering the pressed SMC.

The present disclosure is thus directed to various inventive embodiments of a stator for an axial flux motor that is appreciably simpler and easier to manufacture and assemble with relatively fewer components compared to conventional axial flux motors. The present disclosure is also directed to various inventive methods for assembling axial flux motors, especially stators.

In one aspect, the stator may include multiple coil sets with coils that are directly connected to other coils in a given set. For example, one or both ends of a conductor used to form each coil may be directly welded to corresponding ends of another coil. In another example, multiple coils or, in some instances, all the coils in a coil set may be formed from a single continuous conductor. Multiple coil sets may further be directly connected together via a curved conductor. The number of busbars may be appreciably reduced or, in some instances, eliminated entirely, thus reducing the number of components in the stator. Directly connecting coils together also reduces the number of connection points (e.g., weld points), thus simplifying assembly and reducing assembly time. The ends of respective coils and/or coil sets may also be readily accessible for ease of connection to other coils, coil sets, and/or a support structure supplying electrical power.

In another aspect, the stator may include multiple pole pieces where each pole piece includes multiple laminations stacked onto one another to form a laminated structure. Compared to conventional pole pieces formed from a pressed SMC, the laminated structure may increase the strength of magnetic fields even further, thus providing greater performance. The laminations arranged along different axes are contemplated herein. In one example, tapered laminations may be arranged in a circular arc. In another example, laminations may be stacked along a radial axis.

In yet another aspect, the stator may include a backplane with multiple openings to receive and support the pole pieces. The backplane may be formed from stamped laminations shaped to reduce or, in some instances, mitigate the generation of Eddy currents around each pole piece. This may be achieved, for example, by stacking two different laminations onto one another in an alternating arrangement where each lamination has an electrically insulating coating and is shaped in such a way no continuous electrical path is formed around the openings supporting the pole pieces.

In yet another aspect, the gaps formed between various components of the stator may be partially filled or, in some instances, fully filled with a potting compound (e.g., an electrically insulating material, such as an epoxy). The potting compound may serve several purposes including, but not limited to dissipating heat to reduce or, in some instances, prevent the formation of hotspots within the stator during operation, securely couple and support the various components of the stator to one another to reduce any adverse effects of vibration and shock during operation, and prevent electrical shorting of any electrical components (e.g., coils). The potting compound may be applied in several ways including, but not limited to, a trickle coating process, and a transfer molding process.

A stator formed using the features and concepts disclosed herein may facilitate the manufacture of a stator that can be readily assembled and electrically tested before it ships from a vendor site to a motor build factory with enhanced confidence as to the quality of the finally assembled axial motor.

Although the inventive concepts and features disclosed herein are described and shown in application to an axial flux motor, it should be appreciated these are non-limiting examples and that the concepts and features may be readily applied to electric motors with different architectures. For example, the concepts and features may be readily adapted for use in radial flux motors, especially radial flux motors with concentrated coil windings.

In one example, a stator for an electric motor includes: a hub defining a rotation axis; a support structure, directly coupled to the hub, having one or more traces configured to receive electrical power; and a plurality of coils, electrically coupled to the support structure, to generate one or more magnetic fields from the electrical power, wherein each coil of the plurality of coils is directly coupled in series to at least one other coil of the plurality of coils.

In another example, a stator for a three-phase axial flux motor includes: a hub defining a rotation axis and having a first end and a second end; a support structure, directly coupled to the first end of the hub, having one or more traces configured to receive electrical power corresponding to one of a U phase, a V phase, or a W phase; and a first plurality of coils, disposed on a side of the support structure and electrically coupled to the support structure, to generate one or more magnetic fields from the electrical power corresponding to the U phase; a second plurality of coils, disposed on the side of the support structure and electrically coupled to the support structure, to generate one or more magnetic fields from the electrical power corresponding to the V phase; a third plurality of coils, disposed on the side of the support structure and electrically coupled to the support structure, to generate one or more magnetic fields from the electrical power corresponding to the W phase, wherein: each of the first, the second, and the third pluralities of coils includes: a first group of coils, each coil of the first group of coils being adjacent and directly welded to at least one other coil of the first group of coils; a second group of coils, each coil of the second group of coils being adjacent and directly welded to at least one other coil of the second group of coils; and an electrical conductor, electrically coupled to one coil of the first group of coils and one coil of the second group of coils, to electrically connect in series the first group of coils to the second group of coils; and the first, the second, and the third subsets of coils are nested together and arranged to fully span a circular annulus.

In yet another example, a method for assembling a stator includes: A) assembling a plurality of coils by directly welding at least one end of one coil of the plurality of coils to a corresponding end of another coil of the plurality of coils; B) connecting the plurality of coils to a support structure with one or more traces configured to receive electrical power; C) for each coil of the plurality of coils, inserting a pole piece of a plurality of pole pieces into a first opening defined by that coil; and D) mounting the plurality of pole pieces onto a backplane by inserting respective plug-in portions of each pole piece of the plurality of pole pieces into corresponding second openings of the backplane.

In yet another example, a stator for an electric motor may include at least one support structure with voids through which stator pole pieces may be disposed. The support structure may include one or more ribs shaped and/or dimensioned to form one or more flow channels to direct and guide a coolant liquid, which dissipates heat from the stator during operation. A subset of interconnected coils may be disposed in association with the voids in the support structure. The interconnected coils may include a first portion of a subset of interconnected coils disposed in a first region and a second portion of the subset of interconnected coils disposed in a second region. The stator may further include pole pieces disposed in the voids of the support structure. The pole pieces may each include magnetic laminations having a tapered structure to form, for example, a trapezoidal prism (e.g., a component with a trapezoidal cross-sectional shape).

In yet another example, an apparatus comprises one or more stator support structures that each include any number of voids configured to receive stator pole pieces and coils, a coil support hub coupled to the one or more stator support structures, and conductive material associated with to couple the coils to sources of current.

The coil support hub may comprise a rib structure to support the stator pole pieces. The coil support hub may comprise a flow channel structure to dispose ribs to provide liquid as a coolant to absorb thermal energy originating at any number of stator pole pieces during application of the sources of current. The stator pole pieces may comprise magnetic laminations extending from adjacent a first pole shoe to a second pole shoe. The stator pole pieces may comprise magnetic laminations including tapered structures contributing to formation of a trapezoidal cross-sectional shape for the stator pole pieces. The stator pole pieces may comprise subsets of interconnected coils, whereby a first portion of a subset of interconnected coil may be disposed in a first region and a second portion of the subset of interconnected coil may be disposed in a second region. The one or more stator support structures may each including any number of the voids further comprises a recess structure located adjacent to each void and configured to support a cross-over portion a subset of interconnected coils disposed in a first region and a second region. The apparatus may comprise a stator.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a conventional axial flux motor.

FIG. 1B shows a stator in the axial flux motor of FIG. 1A.

FIG. 2A shows a perspective view of an example support structure for a stator of an axial flux motor.

FIG. 2B shows a front view of the support structure of FIG. 2A with traces to supply electrical power to multiple coils.

FIG. 2C shows a rear view of the support structure of FIG. 2A.

FIG. 2D shows a side view of the support structure of FIG. 2A.

FIG. 3 shows an example coil assembly with the support structure of FIG. 2A.

FIG. 4A shows a perspective view of an example coil set formed from a single continuous conductor where the coils have alternating winding directions.

FIG. 4B shows another perspective view of the coil set of FIG. 4A.

FIG. 4C shows a front view of the coil set of FIG. 4A.

FIG. 5A shows a perspective view of another example coil set formed from a single continuous conductor where the coils have the same winding direction.

FIG. 5B shows another perspective view of the coil set of FIG. 5A.

FIG. 5C shows a front view of the coil set of FIG. 5A.

FIG. 6 shows a perspective view of another example coil set formed from a foil conductor where the coils have alternating winding directions.

FIG. 7A shows an example circuit diagram where the coils are connected according to a three-phase series wye configuration.

FIG. 7B shows an example circuit diagram where the coils are connected according to a three-phase parallel wye configuration.

FIG. 8 shows an exploded view of an example stator subassembly incorporating the coil assembly of FIG. 3.

FIG. 9 shows a perspective view of the coil assembly of FIG. 8 with pole pieces.

FIG. 10 shows a perspective view of an endplate in the stator of FIG. 8.

FIG. 11A shows a front view of an example pole piece with tapered laminations arranged along a circular arc to form a trapezoidal bar.

FIG. 11B shows the pole piece of FIG. 11A wrapped with foil.

FIG. 12A shows a perspective view of an example pole piece with laminations arranged along a radial axis to form a trapezoidal bar.

FIG. 12B shows a front view of the pole piece of FIG. 12A.

FIG. 13A shows an exploded view of an example stator that includes the stator subassembly of FIG. 8.

FIG. 13B shows a front view of the stator of FIG. 13A with labels to indicate a flow of coolant.

FIG. 14A shows an exploded view of an example axial flux motor that includes the stator of FIG. 13A.

FIG. 14B shows a cross-sectional view of the axial flux motor of FIG. 14A.

FIG. 15A shows an example tooling jig to facilitate trickle coating of the stator subassembly of FIG. 8.

FIG. 15B shows an example trickle coating system incorporating the tooling jig of FIG. 15A.

FIG. 16 shows example transfer molding processes applied to the stator subassembly of FIG. 8 and the stator of FIG. 13A.

FIG. 17 shows a perspective view of another example coil assembly with a support structure mounted at one end of a coil support hub and coils mounted to one side of the support structure.

FIG. 18A shows an exploded view of an example stator subassembly that includes the coil assembly of FIG. 17.

FIG. 18B shows a perspective view of the stator subassembly of FIG. 18A.

FIG. 19 shows a perspective view of an example axial flux motor that includes multiple stator subassemblies of FIG. 18A.

FIG. 20 shows a perspective view of an example coil subassembly with two coil sets connected together via a curved conductor.

FIG. 21 shows a perspective view of an example coil assembly that includes multiple coil subassemblies of FIG. 20 for different electrical power inputs.

FIG. 22A shows a perspective view of an example backplane assembly to support the coil assembly of FIG. 21.

FIG. 22B shows a perspective view of the backplane assembly of FIG. 22A with one pole piece partially removed.

FIG. 23 shows a perspective view of a pole piece in the backplane assembly of FIG. 22A.

FIG. 24 shows an exploded view of a backplane in the backplane assembly of FIG. 22A.

FIG. 25A shows a perspective view of another example lamination for a backplane.

FIG. 25B shows a perspective view of yet another example lamination for a backplane.

FIG. 26A shows a perspective view of a single coil according to a first type.

FIG. 26B shows a perspective view of a single coil according to a second type.

FIG. 27 shows a perspective view of an example coil subassembly with two coil sets connected together via a curved conductor formed using the coils of FIGS. 26A and 26B.

FIG. 28A shows a perspective view of an example coil assembly that includes multiple coil subassemblies of FIG. 27 for different electrical power inputs.

FIG. 28B shows another perspective view of the coil assembly of FIG. 28A.

FIG. 29 shows a perspective view of another example coil assembly that includes multiple coil subassemblies for different electrical power inputs. In this example, the curved conductors are disposed along the interior of the coil sets.

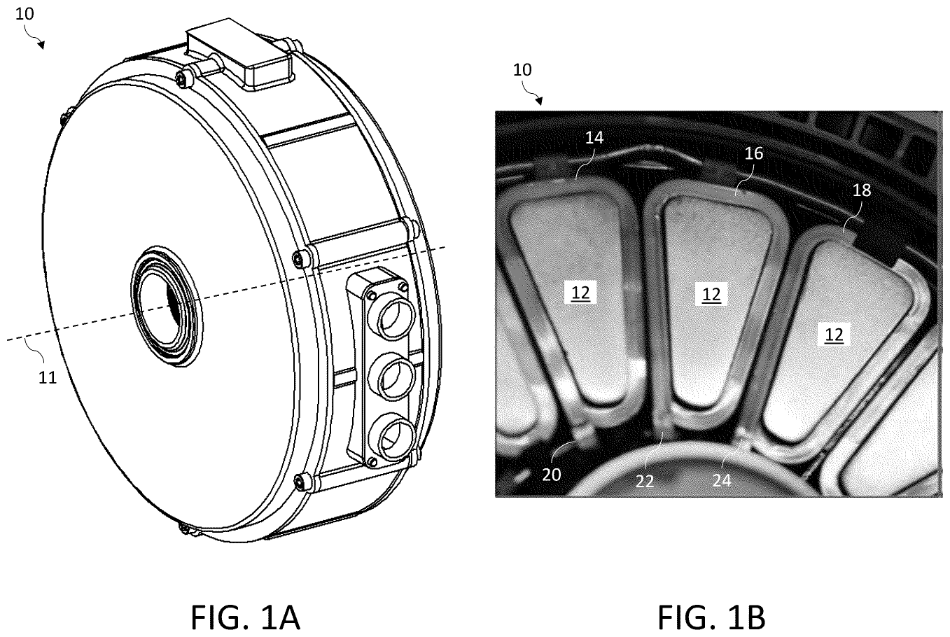

### DETAILED DESCRIPTION

Following below are more detailed descriptions of various concepts related to, and embodiments of, stators for electric motors, especially axial flux motors, with coil assemblies that are appreciably simpler to assemble, pole pieces and a back iron plate with improved performance, and an electrically insulating material to fill any gaps within the stator. The present disclosure is also directed to methods for assembling the stator to include the foregoing features and/or components. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive stators are provided, wherein a given example or set of examples showcases a coil, a coil set comprising multiple coils, a coil assembly comprising multiple coil sets, a support structure, a pole piece, a backplane, and a housing. It should be appreciated that one or more features discussed in connection with a given example of a stator may be employed in other respective examples of stators according to the present disclosure, such that the various features disclosed herein may be readily combined in a given stator according to the present disclosure (provided that respective features are not mutually inconsistent).

Certain parameters and dimensions of the stator are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. an Example Stator With Two-Sided Coil Assembly

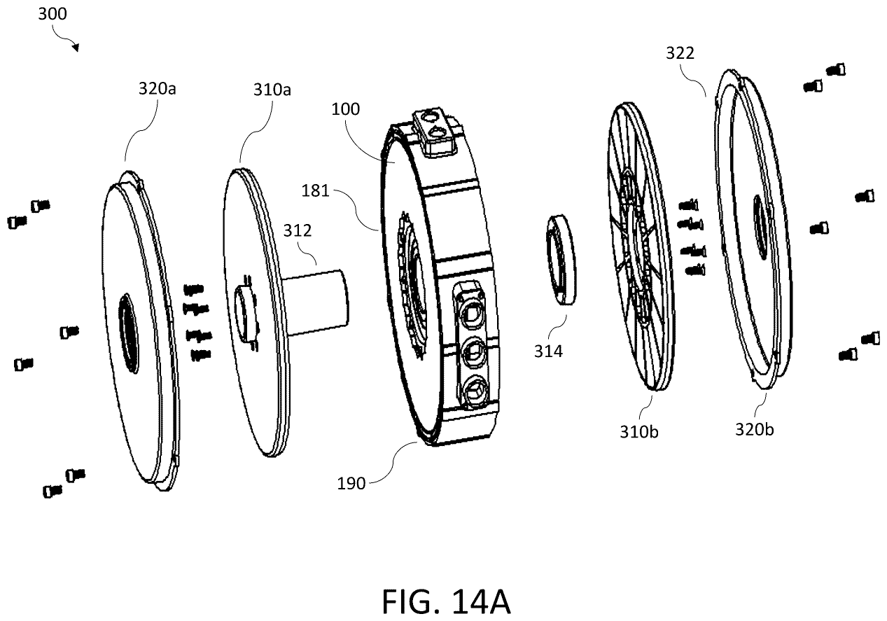

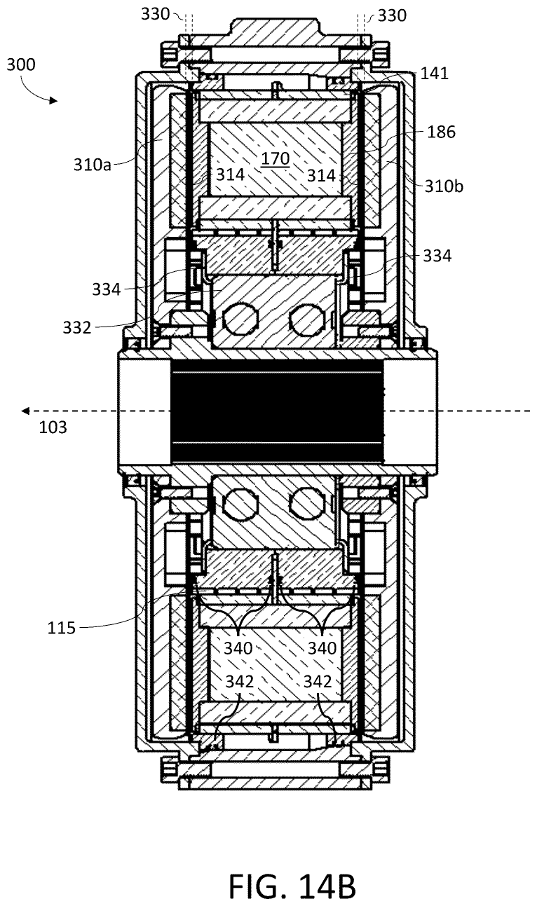

In one example, a stator may include a two-sided coil assembly where a magnetic field is generated along an axial direction from two opposing sides of the stator. This configuration may be used in motors that include a pair of magnetic rotors disposed on opposite sides of the stator, such as the axial flux motor 300 shown in FIGS. 14A and 14B. Following below are further details of an example stator 100 with a two-sided coil assembly.

### 1.1 An Example Support Structure Assembly

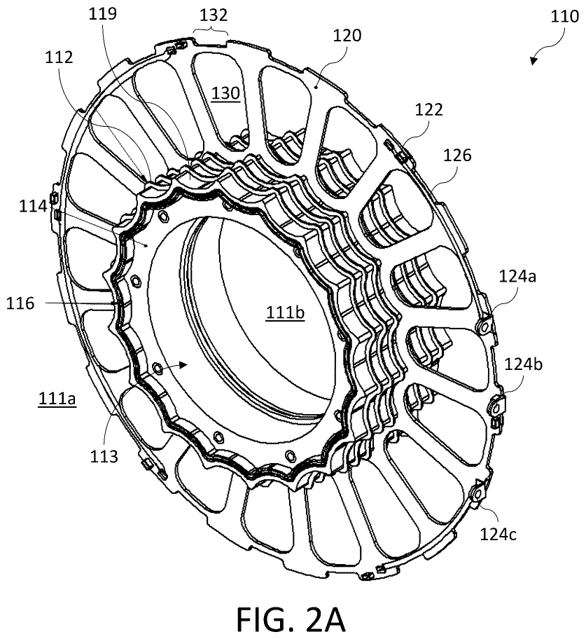

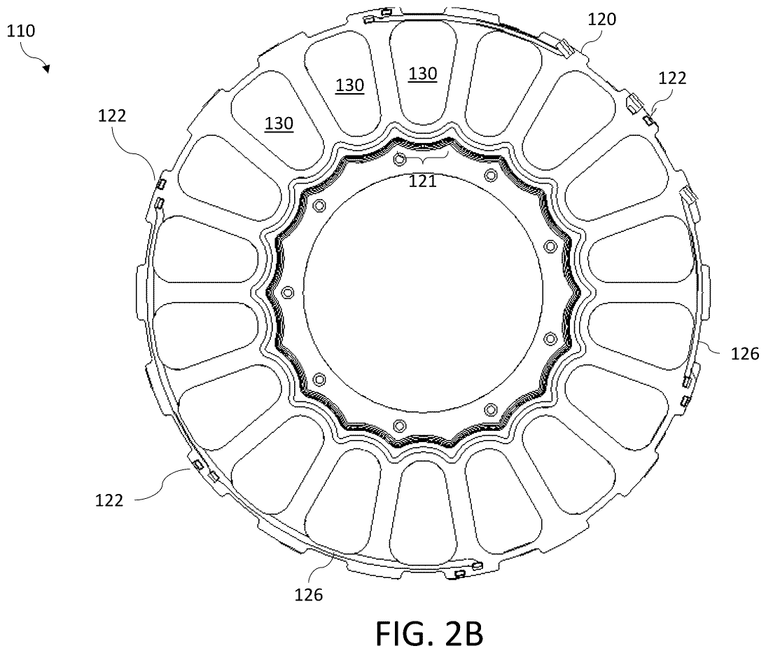

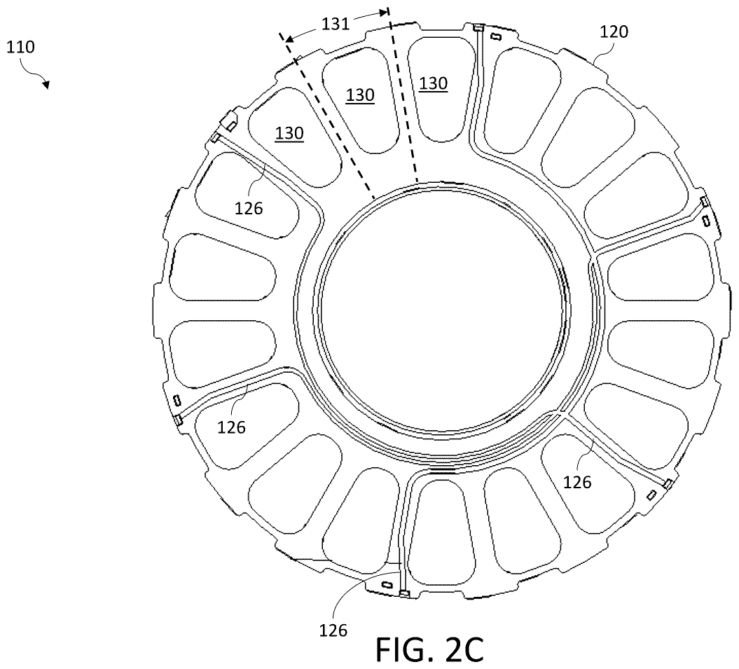

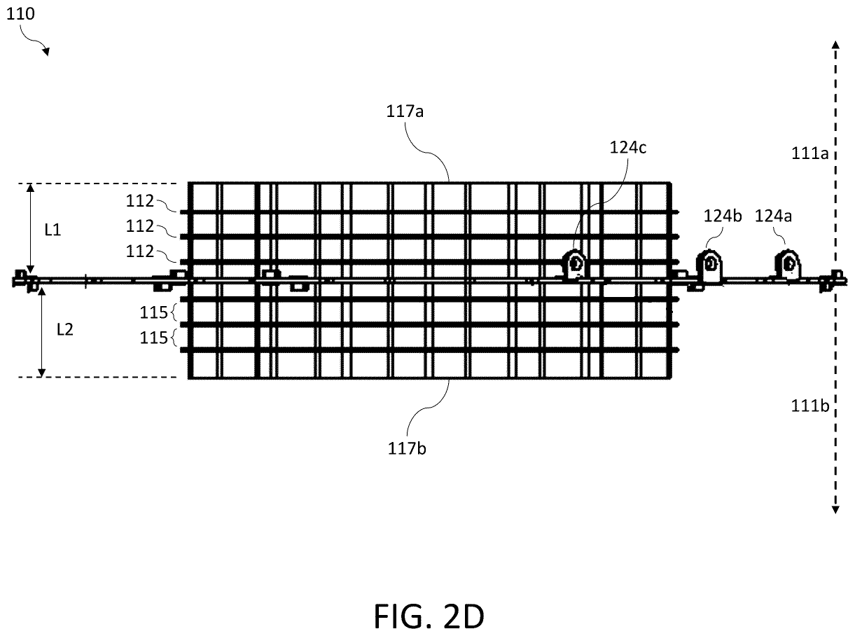

FIGS. 2A-2D show a support structure assembly 110 in the stator 100 to support the two-sided coil assembly. As shown, the support structure assembly 110 includes a coil support hub 114 and a support structure 120 (also referred to herein as a “stator support structure,” “a support plate,” or a “center structure plate”) coupled to the coil support hub 114. In one example, the support structure 120 may be integrally formed with the coil support hub 114. In another example, the support structure 120 may be attached to the coil support hub 114, e.g., via welding, or an adhesive. For instance, the coil support hub 114 may be formed of plastic and attached to both sides of the support structure 120. The coil support hub 114 may further include an opening 113 through which a shaft of the motor (not shown) may be inserted, thus allowing the stator 100 to rotate about and relative to the shaft.

The coil support hub 114 may have an end 117a and an end 117b opposite the end 117a. The support structure 120 may be disposed at the center of the coil support hub 114 equidistant from the end 117a and the end 117b, as shown in FIG. 2D. Here, the support structure 120 may be referred to as a center support structure or a center plate. As a result, the dimensions L₁ and L₂ may be equal. However, it should be appreciated that this is a non-limiting example. More generally, the support structure 120 in this example may be located at any location between the end 117a and the end 117b with the dimensions L₁ and L₂ changing accordingly. For example, the ratio of L₁ and L, where L is equal to the sum of L₁ and L₂, may be equal to about 0.1, about 0.2, about 0.3, about 0.4, about 0.5, about 0.6., about 0.7, about 0.8, or about 0.9. More generally, the ratio of L₁ and L may range from about 0.1 to about 0.9, including all sub-ranges and values in between. The ratio of L₂ and L may be equal to the difference between 1 and the ratio of L₁ and L (i.e., 1−L₁/L).

The coil support hub 114 may further include a rib structure 119 on its exterior surface between the ends 117a and 117b. The rib structure 119 may include multiple concave portions 121 that conform in shape to the coils and/or the pole pieces. The rib structure 119 may further include multiple ribs 112 distributed between the ends 117a and 177b that extend around the coil support hub 114. The ribs 112 may provide a surface to bond to the coils, e.g., via epoxy, thus locking each coil in place to the rib structure 119 and, by extension, the support structure assembly 110.

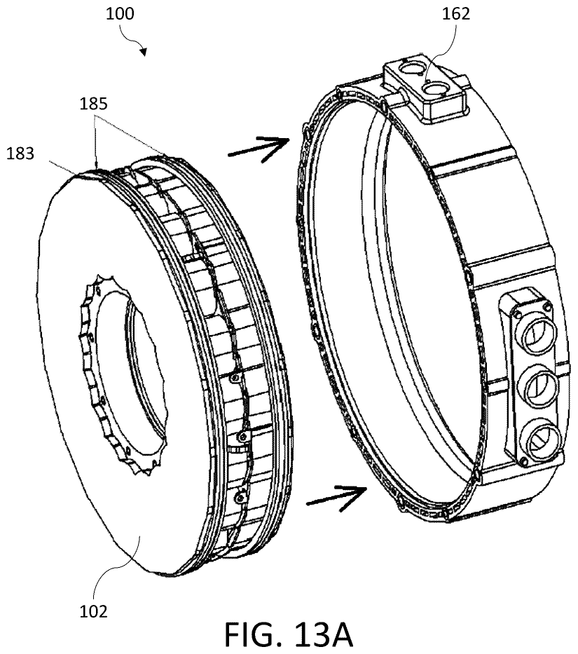

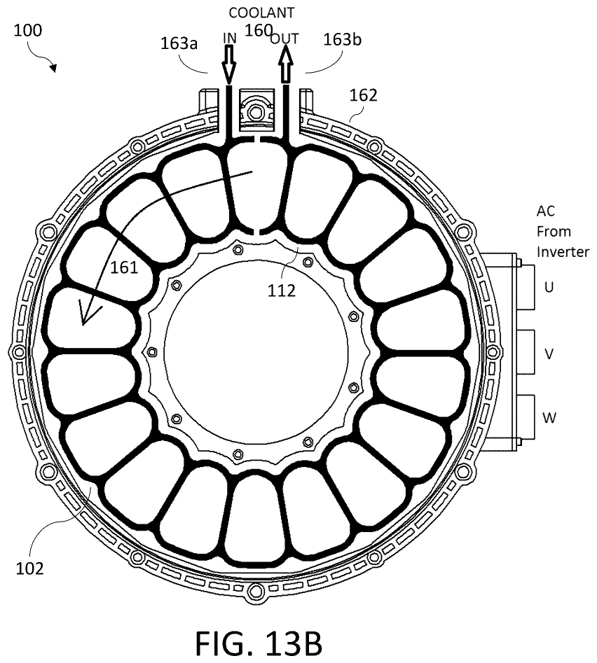

In some instances, the ribs 112 may offset the coils from the coil support hub 114 so that a gap is formed between a portion of the coils and the coil support hub 114. These gaps may thus form part of a flow channel to guide a liquid coolant through the stator 100 (see, for example, FIG. 13B). For example, FIG. 2D shows flow channels 115 may be formed between adjacent ribs 112. The liquid coolant may absorb thermal energy generated by the coils and/or the pole pieces during operation. As shown in FIG. 2D, the ribs 112 and the flow channels 115 may be disposed in both regions 111a and 111b.

An elastomer seal 116 may be coupled to each end 117a and 117b of the coil support hub 114 and/or opposing ends of the support structure 120. The seals 116 may prevent liquid coolant from leaking out of the flow channels 115.

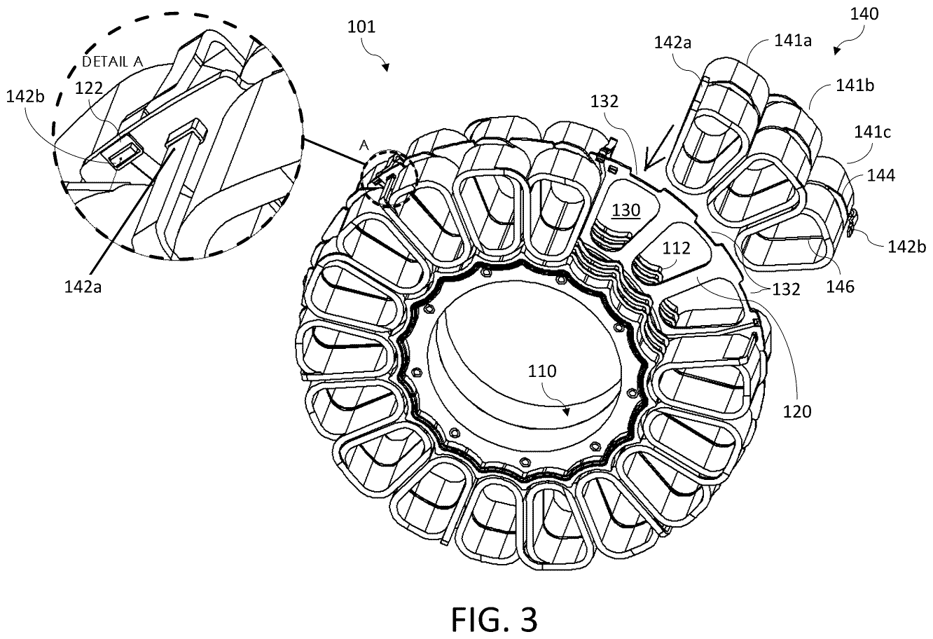

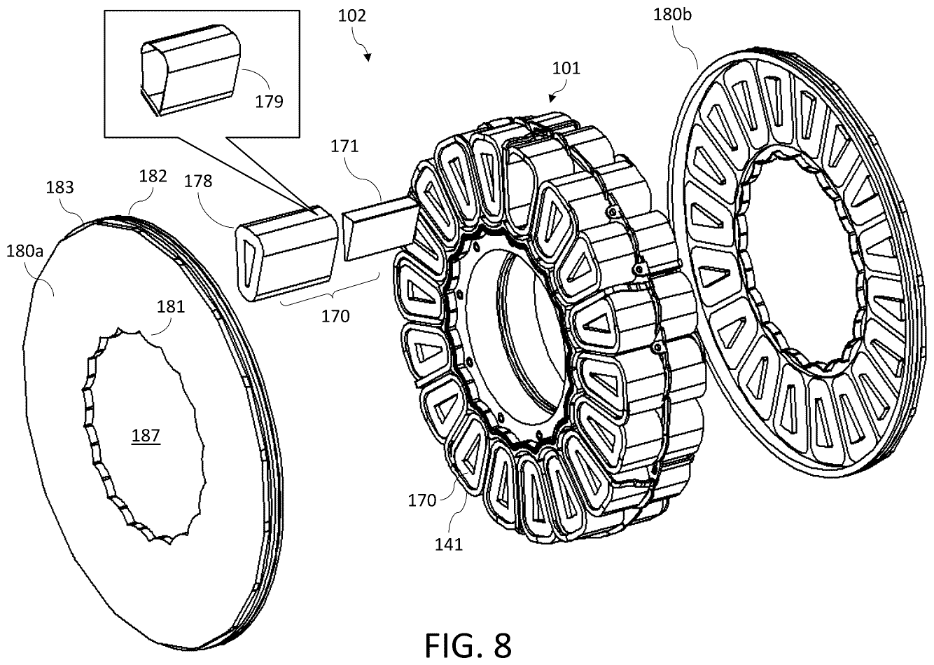

FIGS. 2A-2C further show the support structure 120 may include voids 130 to receive corresponding pole pieces (see, for example, pole piece 170 in FIG. 8). Respective coils (see, for example, coils 141a-141c in FIG. 3) may also be mounted to the support structure 120 and aligned such that openings formed by the coils are aligned with the voids 130. Accordingly, a void 130 herein may refer to a pole piece location.

The support structure 120 may also include connectors 124a, 124b, and 124c to receive, for example, electrical power corresponding to the “U”, “V”, and “W” phases for a three-phased power connection. The support structure 120 may further include multiple electrically conductive traces 126 connected to one of the connectors 124a, 124b, and 124c at one end and a coil coupling receptacle 122 at the other end. As shown in FIGS. 2B and 2C, the traces 126 may be disposed on both front and rear sides of the support structure 120.

The traces 126 may be formed from an electrically conductive material, such as copper or aluminum, to provide electrical connections for at least a subset of the coils. The traces 126 may further be embedded in the support structure 120. The traces 126 may be dimensioned to support the transport of relatively high electrical currents. For example, each trace 126 may be configured to support electrical currents ranging from about 10 A to about 500 A, including all sub-ranges and values in between. The coil coupling receptacles 122 may allow the exposed, bare ends of a coil or coil(s) (i.e., ends with any insulating coating removed) to be inserted and/or plugged in. Further, the receptacles 122 may be positioned on the support structure 120 to be readily accessible for attachment. For example, the ends of the coil may be welded to the receptacles 122 by a welder (e.g., a laser welder). The placement of the receptacles 122 may allow direct line-of-sight with the welder.

In one example, the support structure 120 may be a printed circuit board (“PCB”). For instance, the support structure 120 may be formed from Phenolic FR4/G10, a polymer plastic (e.g., polyether they ketone (PEEK) or polyoxybenzylmethyleneglycolanhydride (“Bakelite”)), or the like. In another example, the support structure 120 may be formed from an overmolded polymer. The support structure 120 may have a thickness of about 2 mm. More generally, the thickness of the support structure 120 may vary from about 1 mm to about 3 mm, including all sub-ranges and values in between.

As shown in FIGS. 2A-2D, the support structure 120 may support eighteen coils and corresponding pole pieces. The voids 130, the coils, and/or the pole pieces may be substantially identical or identical to each other and uniformly distributed about the support structure 120. Thus, each void 130, coil, and/or pole piece may subtend a sector with an angle 131 equal to about 20 degrees. However, it should be appreciated that the support structure 120 is a non-limiting example. For example, the number of voids 130 and corresponding coils and/or pole pieces supported by the support structure 120 may be equal to 6, 12, 18, 24, 30, 36, 42, or 48. More generally, the number of voids 130 and corresponding coils and/or pole pieces supported by the support structure 120 may range from 6 to 48, including all sub-ranges and values in between.

As described above, the stator 100 may support a two-sided coil assembly. This means that, for each coil, a portion of that coil may be disposed in a region 111a (e.g., a front side of the stator 100) and the remaining portion of that coil may be disposed in a region 111b, which is on an opposite side to region 111a (e.g., a rear side of the stator 100).

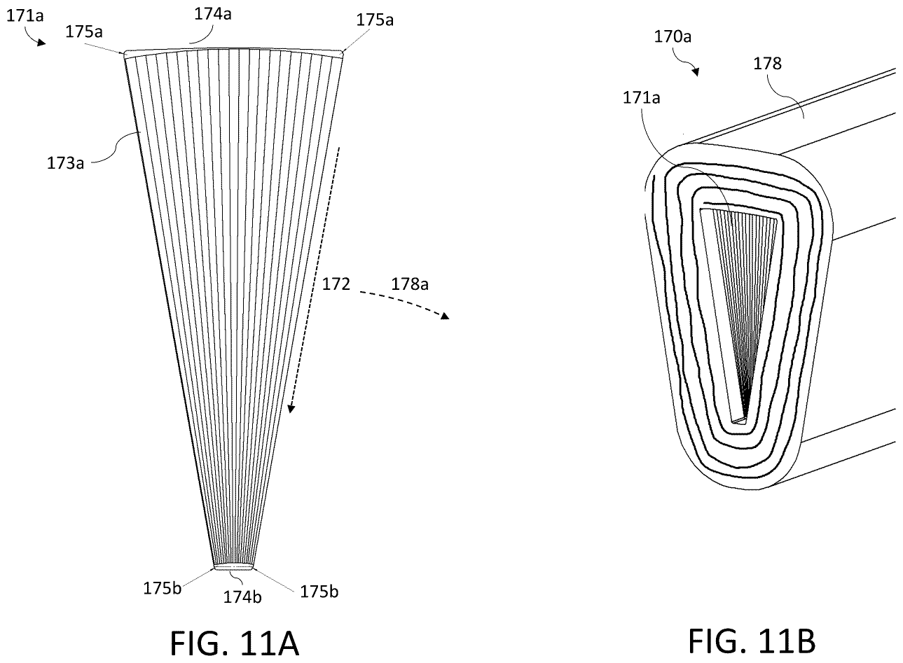

The support structure 120 may further include multiple recesses 132 along the periphery of the support structure 120. The recesses 132 may be aligned with and adjacent to corresponding voids 130 as shown in FIGS. 2B and 2C. Each recess 132 may accommodate a crossover portion of a coil (see, for example, crossover portion 146 in FIG. 3). Additionally, the pole piece inserted through the void 130 may include magnetic laminations that extend from a first pole shoe in region 111a to a second pole shoe in region 111b. The magnetic laminations may include, for example, multiple tapered laminations that are arranged to form a pole piece with a trapezoidal cross-sectional shape (see, for example, the bar 171a in FIG. 11A).

### 1.2 an Example Coil Assembly With Multiple Coil Sets

FIG. 3 shows an example two-sided coil assembly 101 that includes the support structure assembly 110. As shown, the coil assembly 101 may include multiple interconnected coil sets 140 (also referred to herein as a “coil set 140”). The support structure 120 may receive multiple coil sets 140 to form the coil assembly 101.

In this example, each coil set 140 may include three adjacent coils 141a, 141b, and 141c to form a “triplet.” This may be accomplished by winding a single continuous conductor to form all the coils 141a-141c, thus reducing the number of welded connections between the coils and the support structure 120. Additionally, by directly coupling the coils 141 together and each coil set 140 to the support structure 120, the coil assembly 101 may not include any busbars. This, in turn, reduces the likelihood of defective welds (e.g., cracked welds), which may increase electrical resistance and negatively affect the performance of the stator 100.

The coil set 140 may be formed from various conductors including, but not limited to, an electrically insulated round wire, an insulated rectangular wire, insulated foil (e.g., copper or aluminum), and any other suitable conductor. In examples where the coil set 140 is formed from a rectangular wire, the thickness of the wire may be about 1 mm. More generally, the thickness or diameter of the conductor may range from about 0.5 mm to about 2 mm, including all sub-ranges and values in between.

Each coil 141a, 141b, and 141c may be formed from a set number of windings of the conductor (also referred to “turns”). Compared to conventional coils, the coils disclosed herein may include a conductor with a relatively larger cross section, resulting in fewer turns. Since the conductor typically includes an electrically insulating coating, a smaller number of turns reduces the amount of insulating material and increases the amount of conductor material present in each coil. In one example, the number of turns for each coil may be equal to 19. More generally, the number of turns may range from about 15 to about 25, including all sub-ranges and values in between.

Furthermore, the coil set 140 may include ends 142a and 142b to facilitate connection to the support structure 120. Specifically, the ends 142a and 142b may each include an exposed conductor (i.e., a conductor with any insulating coating removed). The ends 142a and 142b may be inserted into respective receptacles 122 on the support structure 120, as shown in the inset Detail A of FIG. 3. The ends 142a and 142b may then be welded from the opposing side.

The coils 141a, 141b, and 141c may each include crossover portions 142a, 142b, and 142c, respectively, to facilitate connection of the coil set 140 to the support structure 120. As shown in FIG. 3, each crossover portion 142a, 142b, and 142c extends across a gap 146. When mounting the coil set 140 to the support structure 120, the respective portions of the support structure 120 with the recess 132 may pass through the gap 146 of each coil until the crossover portions 142a, 142b, and 142c abut and engage respective portions of the support structure 120 with the recess 132. Additionally, the coil set 140 may engage with the rib 119. In this manner, the coil set 140 may mechanically engage and couple to the support structure 120.

In this example, the support structure 120 may include twelve receptacles 122 (i.e., two receptacles 122 for each coil set 140 with six coil sets 140 total). As described above, the support structure 120 may supply electrical power to respective coil sets 140 via corresponding traces 126. The electrical power supplied to the coil sets 140 may be divided between electrical power input corresponding to the U, V, and W phases for a three-phased power connection. For example, a pair coil sets disposed diametrically opposite to one another may receive electrical power from the same phase. This means the electrical power for each phase may be supplied to two coil sets and, thus, six coils in total. Thus, the coil assembly 101 may include 18 coils total (e.g., with 16 magnet poles).

It should be appreciated that the number of coils in each coil set 140 and the total number of coils in the coil assembly 101 are non-limiting examples. More generally, each coil set 140 may include any number of coils. For example, the number of coils in each coil set 140 may range from 2 to 12, including all sub-ranges and values in between. Similarly, the total number of coils may include more or less coils than shown in FIG. 3. For example, the number of coils may be equal to 6, 12, 18, 24, 30, 36, 42, or 48. More generally, the number of coils may range from 6 to 48, including all sub-ranges and values in between. The number of receptacles 122 may change according to the number of coil sets 140. For example, the number of receptacles 122 may range from about 12 to about 24, including all sub-ranges and values in between.

Additionally, the total number of coils may be evenly divided by the number of electrical power inputs corresponding to different phases. For example, in a three-phase motor, a coil assembly comprising 30 coils may include 10 coils for each phase (e.g., U, V, W phases). Moreover, the number of coils receiving an electrical power input corresponding to a particular phase may be divided in half and disposed diametrically opposite to one another about the coil hub support 114.

Various designs of a coil set 140 are contemplated herein.

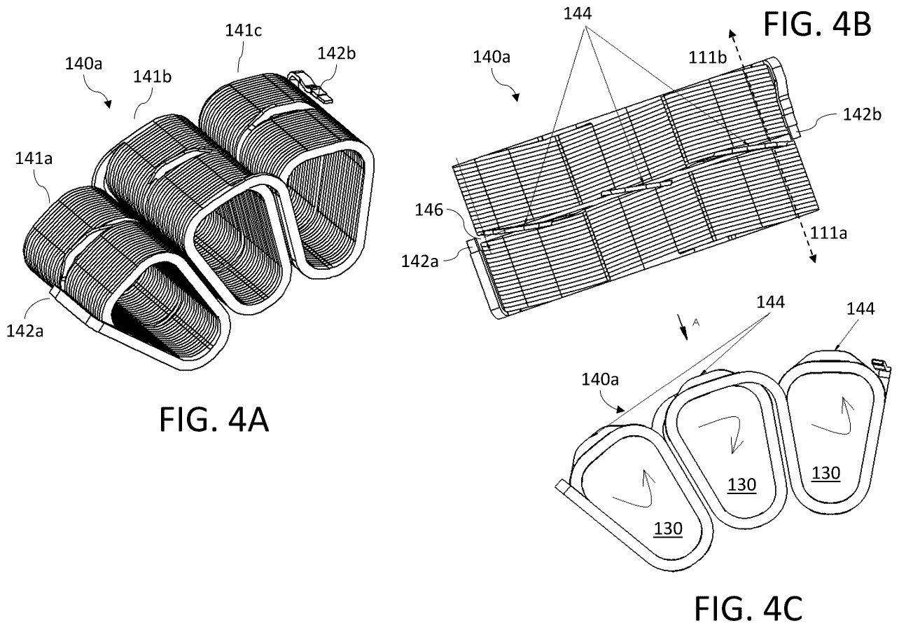

FIGS. 4A-4C show an example coil set 140a formed using a continuous insulated rectangular wire with exposed ends 142a and 142b, i.e., ends with the insulating coating removed to facilitate welding. In this example, the coil set 140a may include coils 141a, 141b, and 141c, thus forming a triplet. FIG. 4C shows the coils 141a and 141c may each be formed by bending the rectangular wire in a counterclockwise direction and the coil 141b may be formed by bending the rectangular wire in a clockwise direction. Thus, the winding directions may alternate between adjacent coils in the coil set 140a. FIG. 4B further shows the respective coils 141a, 141b, and 141c of the coil set 140a may form respective crossover portions 144 that cross corresponding gaps 146.

The crossover portions 144 may “jump” or “jog” over the gap 146. The crossover portions 144 may further be disposed along an outer portion of the coil set 140a and be shaped to engage with the support structure 120. The crossover portion 144 may span one width of the conductor. For the stator 100, a portion of the coil set 140a may be disposed in the region 111a and another portion of the coil set 140a may be disposed in the region 111b. Generally, the location of the crossover portions 144 and the gaps 146 may be located at any position along the length of the coil set 140a. Accordingly, the number of coil windings disposed in the regions 111a and 111b may vary.

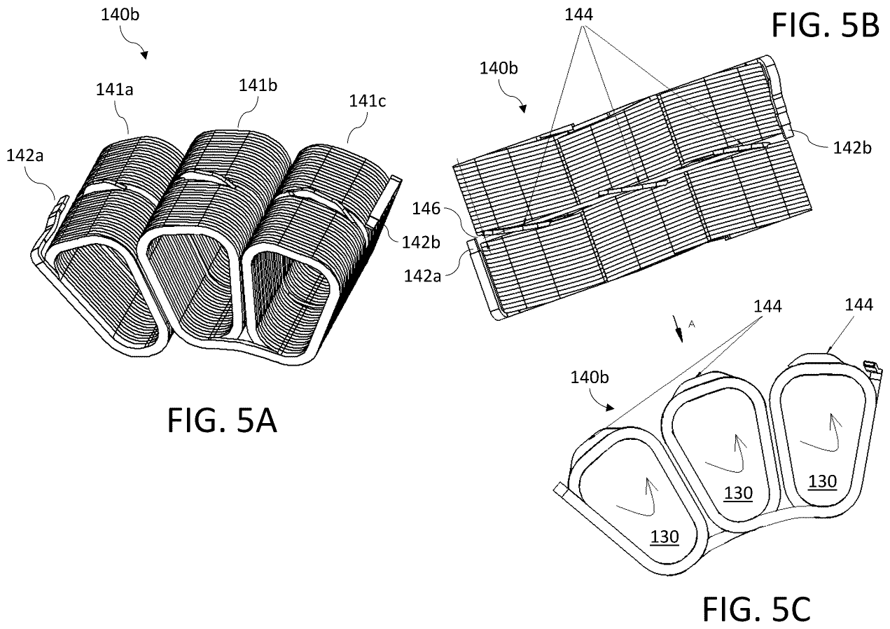

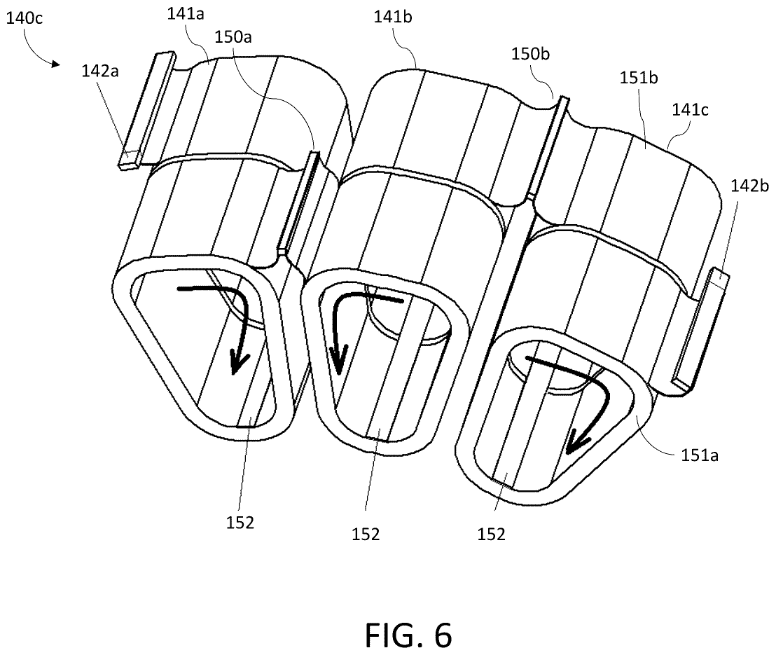

FIGS. 5A-5C show an example coil set 140b formed using a continuous insulated rectangular wire with exposed ends 142a and 142b. The coil set 140 may include coils 141a, 141b, and 141c to form a triplet. In this example, the coils 141a, 141b, and 141c are all wound in a counterclockwise direction, as shown in FIG. 5C. In some cases, the coil 140b may form a motor with 12 poles (e.g., rather than 18 or 20 poles). Similar to the coil set 140a, the coil set 140b may include three coils (e.g., coils 141a, 141b, and 141c) wound in a manner to form crossover portions 144 that extend across a gap 146.

The crossover portions 144 may again “jump” or “jog” over the gap 146 and engage with the support structure 120. For the stator 100, a portion of the coil set 140b may be disposed in the region 111a and another portion of the coil set 140b may be disposed in the region 111b. Generally, the location of the crossover portions 144 and the gaps 146 may be located at any position along the length of the coil set 140b. Accordingly, the number of coil windings disposed in the regions 111a and 111b may vary.

FIG. 6 shows another example coil set 140c formed from a foil conductor with exposed ends 141a and 141b. Specifically, the coil set 140c may include coils 141a, 141b, and 141c formed from a foil conductor. The foil conductor may be formed from various materials including, but not limited to, copper and aluminum. Additionally, the foil conductor may include one or more layers formed of an electrically insulating material, such as an oxide insulation layer. The foil conductor may be relatively thin with a thickness less than or equal to about 25 μm. As shown in FIG. 6, the coil 141a may be directly coupled to the coil 141b via, for example, a coil plug 150a. Similarly, the coil 141b may be directly coupled to the coil 141c via a coil plug 150b. Additionally, the coil set 140c may include conductor strips 152 to physically connect a front coil section 151a to a rear coil section 151b. The front and rear coil sections 151a and 151b may be respectively disposed in regions 111a and 111b of the coil assembly.

The coil set 140c may further include foil coil ends 142a and 142b to facilitate connection to the support structure 120. Compared to conventional foil conductor-based axial flux motors, the coil set 140c may provide three coils with only two ends for connection resulting in fewer welded connections. In total, a coil assembly may include six coil sets 140c and, thus, twelve receptacles 122 to facilitate connection to the coil sets 140c.

FIG. 6 further shows respective front and rear coil sections 151a and 151b of the coils 141a, 141b, and 141c of the coil set 140c may be connected together in accordance with a series wye configuration. Said another way, the front and rear coil sections 151a and 151b of each coil is connected in series and the coils 141a, 141b, and 141c are further connected in series. It should be appreciated that this arrangement is a non-limiting example. In another example, the coils 141a, 141b, and 141c may be connected together in accordance with a parallel wye configuration. This may be accomplished, for example, by connecting respective front coil sections 151a of the coils 141a, 141b, and 141c together via coil plugs and, separately, connecting respective rear coil sections 151b of the coils 141a, 141b, and 141c together via coil plugs. In this example, the foil coil end 142a may be connected to the front and rear coil sections 151a and 151b of the coil 141a and, similarly, the foil coil end 142b may be connected to the front and rear coil sections 151a and 151b of the coil 141c.

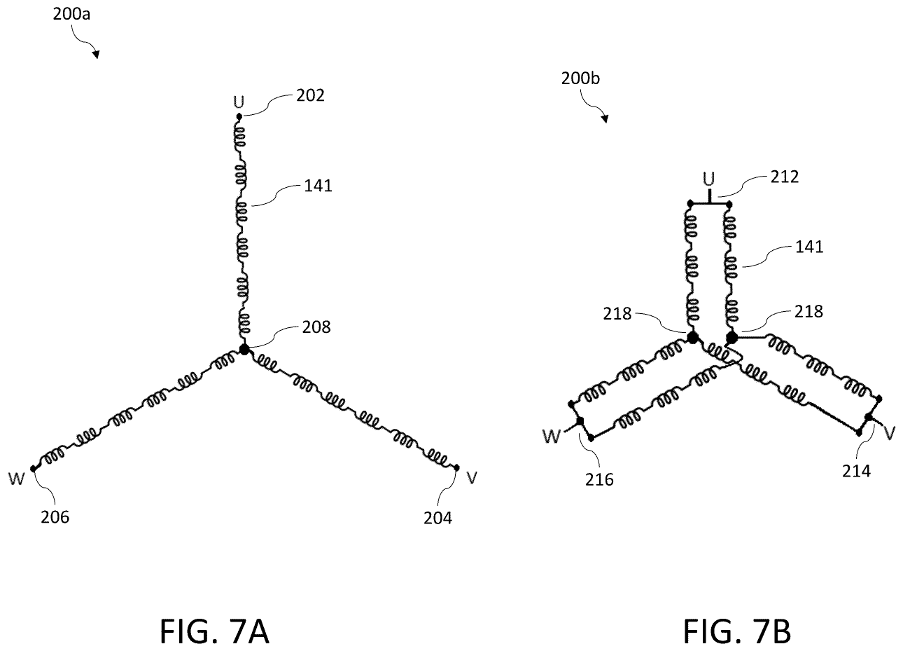

The coil sets and the coil assemblies disclosed herein may be electrically connected together in different ways. In one example, FIG. 7A shows a schematic representation of a three-phase series wye configuration 200a for an eighteen (18) coil stator (e.g., with 16 or 20 magnet poles). The coil assembly 101 of FIG. 3 is an example of this configuration where six coil sets 140 (with each coil set 140 formed using a single wire) are connected to the support structure 120 to provide 18 coils in total. Referring to FIG. 7A, the coils 141 may be divided between the current sources 202, 204, and 206 corresponding to the U, V and W phases. Thus, there may be six coils 141 connected to each current source 202, 204, and 206 and the central node 208.

In another example, FIG. 7B shows a schematic representation of a three-phase parallel wye configuration 200b with eighteen (18) coils. As shown, the coils 141 may be divided evenly into three sets containing six coils 141 each for the current sources 212, 214, and 216, which correspond to the U, V and W phases, respectively. The coils 141 in each set may be further divided evenly into two subsets containing three coils 141 each. Each of the subsets of coils may be connected to one of the current sources 212, 214, and 216 and one of the two central nodes 218. In this manner, the coils 141 for each current source 212, 214, and 216 may be arranged in a parallel network. The parallel wye configuration may provide a way to manufacture and assemble low voltage axial flux motors. Moreover, the manufacture and assembly of the low voltage axial flux motors may use similar or even the same manufacturing processes used to manufacture and assemble series-based wye configurations for high voltage axial motors.

It should be appreciated that the number of coils and connections in the series wye configuration 200a and the parallel wye configuration 200b are non-limiting. More generally, each of these configurations may include more or fewer coils 141 and/or more or fewer coil sets 140. For example, the total number of coils may range from 6 to 48. For a three-phase motor, the number of coils connected to each current source may range from 2 to 16. Accordingly, the number of welded connections to the support structure 120 may also vary depending on the number of coils 141 and/or the number of coil sets 140 present. For example, if the coil assembly includes twelve coil sets 140 and each coil set 140 includes three coils (for a total of 36 coils), the number of welded connections may be 24.

### 1.3 an Example Stator Subassembly

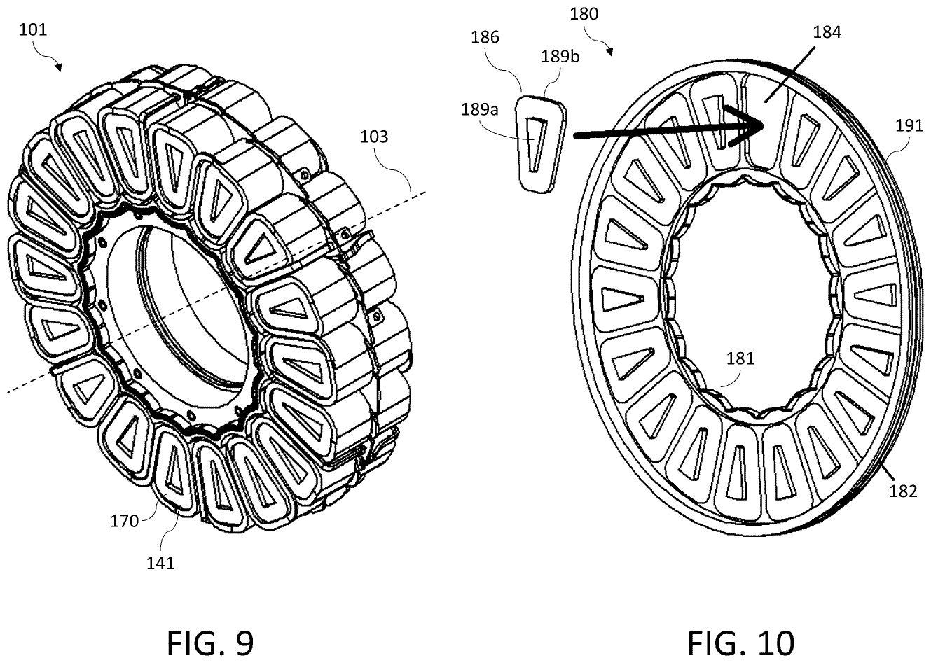

FIG. 8 shows an exploded view of a stator subassembly 102 that includes the coil assembly 101 described in Section 1.2. As shown, each coil 141 of the stator subassembly 102 may include a cavity to receive and contain a pole piece 170. The pole piece 170 may also be inserted through a corresponding void 130 of the support structure 120. FIG. 9 shows the coil assembly 101 with pole pieces 170 inserted into each of the coils 141 such that each pole piece 170 is surrounded by the coil 141. As shown, the pole pieces 170 may be arranged in a radially symmetric manner about a center axis 103 (e.g., the rotation axis of the stator 100).

Each pole piece 170 may include a bar 171 disposed within a wrapping 178. The bar 171 may include, for example, tapered laminations formed from a soft magnetic steel and arranged to form a trapezoidal shape (see, for example, the laminations 173a in FIG. 11A) to carry a magnetic flux. The bar 171 may further be overmolded with an electrically insulating material. The wrapping 178 may be formed from one or more laminations, such as a rolled foil of soft magnetic steel. The pole piece 170 may further be disposed in a shelled bobbin insulator 179. The bobbin insulator 179 may be formed from extruded plastic to provide an electrically insulating barrier to protect the pole piece 170, for example, against wear from the surrounding coil 141.

The stator subassembly 102 may further include end plates 180a and 180b (also referred to as an end plate 180) coupled to opposite sides of the coil assembly 101. The end plate 180 may include an array of convex portions 181 disposed about a center opening 187 that aligns with the concave portions of the rib structure 119 of the coil support hub 114. The end plate 180 may further include facets 183 disposed along the periphery to facilitate a transfer of torque with a housing (see, for example, the housing 162 in FIG. 13A). This prevents the stator subassembly 102 from moving relative to the housing, as discussed further below. The end plate 180 may also include a groove 182 for an O-ring to seal the stator subassembly 102 when inserted into a housing (see, for example, the housing 162 in FIG. 13A).

FIG. 10 shows the end plate 180 may include a backplane 191 with attachment regions 184 for each coil 141 of the stator subassembly 102. A pole shoe 186 may be attached to each attachment region 184. Each pole shoe 186 may include a protrusion 189a that extends into the wrapping 178 for each pole piece 170. The attachment regions 184 may further be dimensioned to be relatively thin such that a base portion 189b of the pole shoe 186 forms a desired air gap with the coil 141 and/or the pole piece 170. The backplane 191 may be formed from plastic. The pole shoe 186 may be formed from a soft magnetic composite (SMC).

FIG. 11A shows an example bar 171a configured to carry magnetic flux as part of the pole piece 170. As shown, the bar 171a may be formed into a trapezoidal shape (e.g., a trapezoidal prism). The bar 171a may be formed using tapered laminations 173a. Each lamination 173a may have a first thickness further from an axis of rotation 103 of the stator 100 and a second thickness, thinner than the first thickness, closer to the axis 103 of the stator 100. The thickness of the bar 171 may change gradually from the first thickness to the second thickness along a tapering direction 172.

Each tapered lamination 173a may be formed, for example, by a rolling process. For example, a steel plate may be rolled to form a taper with desired dimensions. The angle of the taper may be chosen such that, when multiple laminations 173a are stacked together, the bar 171a is formed with a desired shape (e.g., a trapezoidal shape). The taper angle may be modified to change the shape and/or dimensions of the bar 171a. The laminations 173a, when stacked, may follow a circular arc indicated by the axis 178a. In some embodiments, the axis 178a may correspond to a polar axis centered about the rotation axis 103 of the stator 100.

In one example, the bar 171a may be formed by placing a stack of tapered laminations 173a into a die and over molding the stack with a polymer. In another example, a SMC powder press process may be used where a stack of laminations 173a is pressed together with SMC powder to form a bar 171a with a relatively smooth perimeter. For example, the corners of the bar 171a may have corner filets having a corner radius. As shown in FIG. 11A, the process may result in a bar 171a with material regions 174a and 174b formed from the SMC powder. The material region 174a may have corner filets with corner radii 175a. The material region 174b may have corner filets with corner radii 175b. For example, the corner radii 175a and 175b may be equal to about 0.3 mm.

The laminations 173a may each include a relatively thin insulation layer, such as an oxide or a glass coating. The relatively smooth perimeter of the bar 171a may be wrapped using a strip material, such as a foil formed from a soft magnetic material with an insulation layer (see, for example, the foil wrap 178 of FIG. 11B). One or both of the tapered laminations 173a and the foil wrap 178 may be formed from a soft magnetic steel including, but not limited to, a grain-oriented silicon electrical steel, a cobalt-iron steel, non-grain-oriented silicon iron with a C5 coating, and the like. The foil wrap 178 may include an oxide insulation layer to prevent or reduce eddy currents in the bar 171a.

It should be appreciated the bar 171a is a non-limiting example and that, more generally, other bars may be used in the stator subassembly 102. The bars may be formed using other techniques, such as by combining SMC material and laminations, and/or by using SMC only to form a bar.

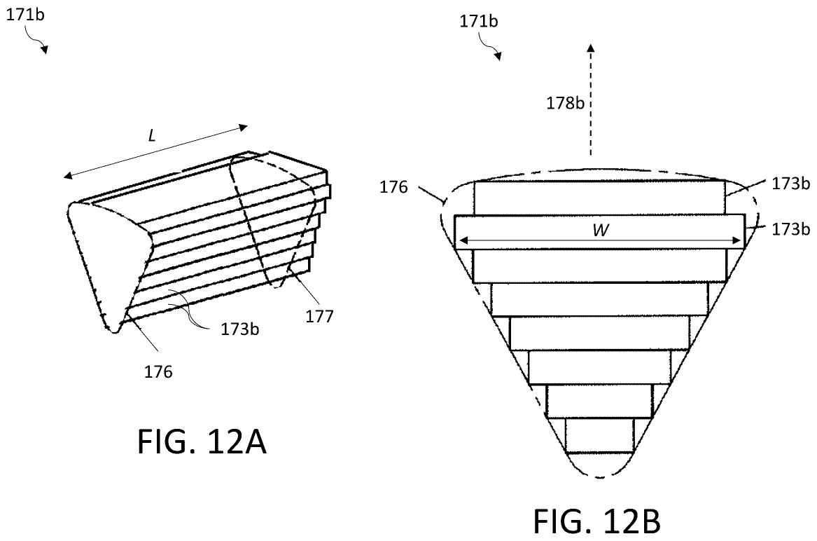

For example, FIGS. 12A and 12B show a bar 171b formed from laminations 173b stacked along an axis 178b parallel or, in some instances, coincident with a radial axis extending from the rotation axis 103 of the stator 100. Said another way, the lengths of the laminations 173b, L, may be parallel to the rotation axis 103. As shown in FIG. 12B, the laminations 173b may have varying widths, W, to form a desired cross-sectional shape 177 (e.g., a trapezoid). As a result, the bar 171b may be shaped as a trapezoidal prism. The laminations 173b may be stacked to form pole faces 176 that are relatively flat to face the pole shoes 186 of the end plates 180. The thickness of the laminations 173b may be relatively uniform (e.g., variations may arise due to tolerances in manufacture). However, it should be appreciated that, in some embodiments, the thickness of the laminations 173b may be deliberately varied in conjunction with a varying width. The thickness of the laminations 173b may be equal to or less than about 0.25 mm.

In one example, the laminations 173b may be overmolded with a polymer to form a relatively smooth exterior shape suitable for foil wrapping (see, for example, the foil wrap 178). In another example, the laminations 173b may be pressed together with SMC powder similar to the bar 171a to form a relatively smooth exterior shape. In yet another example, the laminations 173b may be extruded with a polymer binder to create a relatively smooth exterior.

### 1.4 an Example Stator and Axial Flux Motor

FIG. 13A shows an example stator 100 that incorporates the stator subassembly 102 described in Section 1.3. As shown, the stator subassembly 102 may be inserted into a housing 162. O-rings 185 may be disposed on the grooves 182 of the end plates 180 to form a sealed cavity with the housing 162 that contains the coil assembly 101. Additionally, the facets 183 may engage corresponding facets on the housing 162 to ensure that when a reactive torque is applied to the stator subassembly 102 during operation, the stator subassembly 102 does not move relative to the housing 162.

The sealed cavity of the stator 100 may provide a way to directly cool the coil assembly 101 with liquid coolant. For example, FIG. 13B shows a cross-sectional view of the stator 100 with liquid coolant 160 flowing through the stator subassembly 102 from an input port 163a to an output port 163b. As shown, the liquid coolant 160 may flow along a path 161 that allows the liquid coolant 160 to physically contact the surfaces of the coils 141. This is facilitated, in part, by channels being formed between the coils 141 and the support structure assembly 110 (e.g., the rib structure 119) and/or the housing 162. It should be appreciated that the stator 100 is a non-limiting example and that other approaches to cool the stator 100 and, more generally, the electric motor are contemplated herein. For example, a fluid conduit may be coupled to and/or integrally formed onto the exterior of the housing 162 and/or the bell covers (see, for example, the bell covers 320a and 320b in FIG. 14A).

FIGS. 14A and 14B show an axial flux motor 300 that incorporates the stator 100. As shown, the motor 300 includes a shaft 312 coaxially aligned with the rotation axis 103. The motor 300 further includes magnetic rotors 310a and 310b disposed on opposing sides of the stator 100 and coupled to the shaft 312. The magnetic rotors 310a (also referred to as the “left magnet plate 310a”) and 310b (also referred to as the “right magnet plate 310b”) may be securely coupled to the shaft 312 such that the magnetic rotors 310a and 310b and the shaft 312 rotate together. However, it should be appreciated that the magnetic rotors 310a and 310b may be rotatable relative to the shaft 312 (e.g., via one or more bearings disposed between the magnetic rotors 310a and 310b and the shaft 312). FIG. 14B shows the shaft 312 may be assembled into bearing structure 322.

The stator 100 may be securely coupled to the bell cover 320a (also referred to as the “left end bell plate cover 320a”) and the bell cover 320b (also referred to as the “right end bell plate cover 320b”). This may be accomplished, for example, using one or more bolts to securely fasten the bell covers 320a and 320b to the stator 100. FIG. 14A further shows the motor 300 includes a press ring 314 through which the shaft 312 can enter and pass through. Thus, the press ring 314 (e.g., a shaft press ring) may be disposed on the shaft 312.

The stator 100 may further include O-rings 190 disposed within corresponding O-ring grooves in the stator 100 to form a seal with the bell covers 320a and 320b. The O-rings 190 may be the same or different from the O-rings 185. The stator 100 may also include facets 181 (e.g., torque transfer facets) to engage corresponding facets 322 (e.g., torque transfer facets) on the bell covers 320a and 320b. That way, the stator 100 and the bell covers 320a and 320b are mechanically constrained to each other, i.e., the stator 100 cannot move relative to the bell covers 320a and 320b and/or torque transfer may occur between the housing 162 of the stator 100 and the bell covers 320a and 320b.

FIG. 14B further shows the motor 300 may include a bearing structure 322. The bearing structure 322 may be a double row ball bearing structure. The bearing structure 322 may be locked internally in a stator bore by retainers 334. In some examples, the retainers 334 may be stamped sheet metal bearing retainers.

The motor 300 may further include air gaps 330, which may be defined, in part, by the support structure 120 supporting the pole pieces 170 and the coils 141. The air gaps 330 may have a desired air gap size, position, and/or other characteristics. For example, the air gap size may range from about 0.2 mm to about 2 mm, including all sub-ranges and values in between. The support structure assembly 110 may facilitate alignment of the pole faces of the pole pieces 170 and the magnetic pole shoes 186 and/or maintain a desired air gap during assembly of the stator 100 and/or during operation of the stator 100.

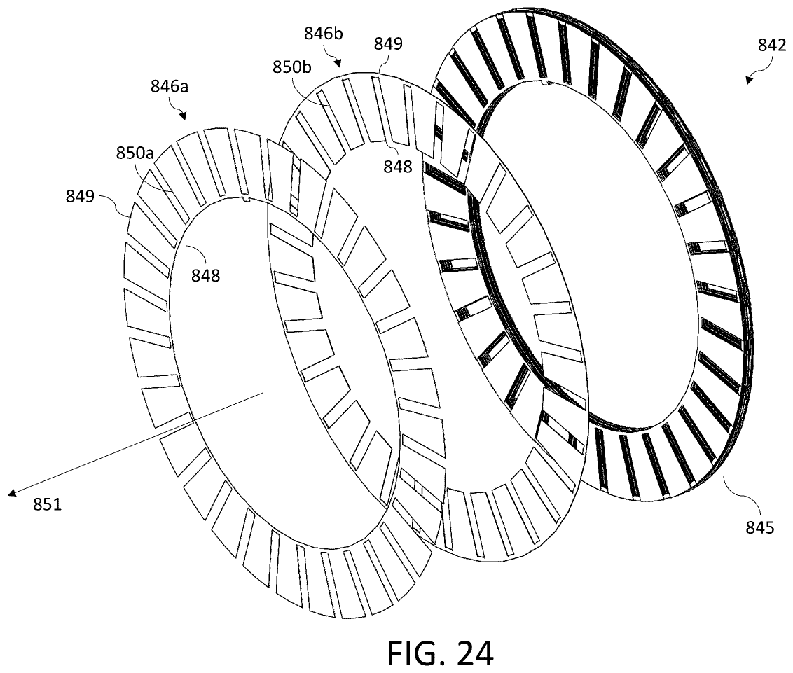

The motor 300 may further include a backplane 334 supporting the pole shoes 186. For example, the backplane 334 may be disposed behind the pole shoes 186. The backplane 334 may be formed of a laminated back iron material (see, for example, the backplane 842 in FIG. 24).

FIG. 14B further shows the motor 300 may include multiple cooling channels 115 around the coils 141 to carry liquid coolant to dissipate heat generated by the coils 141 during operation. The channels 115 may be formed around any number of coils 141. In some embodiments, the channels 115 may be formed around all the coils 141. The motor 300 further includes multiple fluid seals 340 disposed on the inside edge of the support structure 120 and multiple fluid seals 342 disposed on the outside edge of the support structure 120.

Although the motor 300 is shown to be a three-phase motor, it should be appreciated that this is a non-limiting example. More generally, the concepts and features of the stator 100 may be readily incorporated into other types of motors, such as a single-phase motor. Additionally, the concepts and features of the stator 100 disclosed herein may be applied to other devices and systems, such as a generator, or a combination of a generator and a motor during different modes of operation.

### 1.5 Example Processes for Potting the Stator

Once the stator subassembly 102 is assembled, it may be desirable to introduce a potting compound to partially fill or, in some instances, completely fill any gaps between the various components of the stator subassembly 102 (e.g., gaps formed between adjacent coils 141). The potting compound may serve several functions including, but not limited to, dissipating heat to reduce or, in some instances, prevent the formation of hotspots within the stator during operation, securely couple and support the various components of the stator to one another to reduce any adverse effects of vibration and shock during operation, and prevent electrical shorting of any electrical components (e.g., coils). For example, the potting compound may be a commercial product, such as Sumitomo Bakelite North America, Inc. M200T Type NA. In some embodiments, the potting compound may only partially fill the gaps in the stator subassembly 102 so that channels 115 may still be formed to carry liquid coolant.

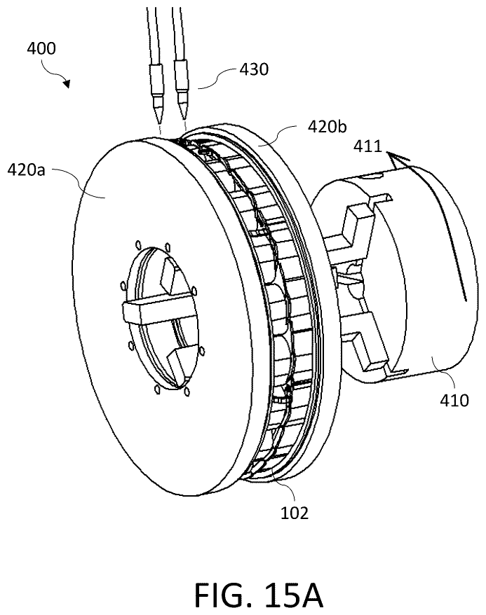

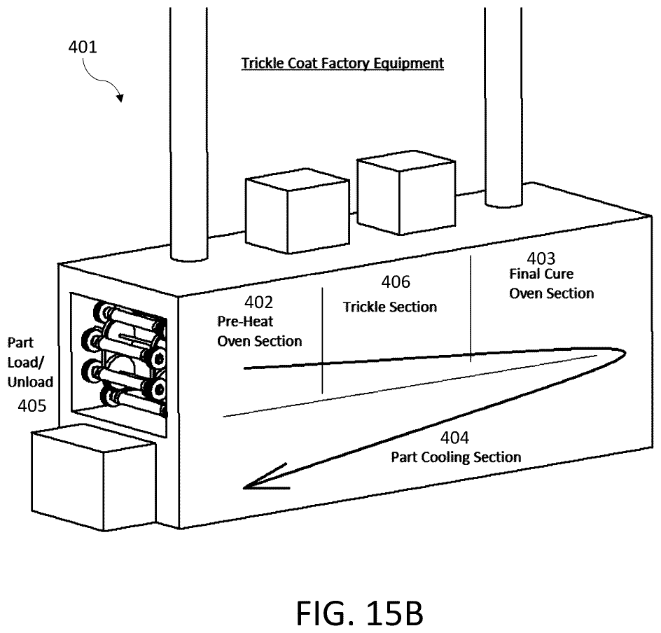

In one example, the potting compound may be introduced using a trickle coating process. FIG. 15A shows an example tooling jig 400 to facilitate application of a potting compound. In particular, the jig 400 may secure the stator subassembly 102 according to a desired alignment with respect to one or more nozzles 430 during the trickle coating process. The jig 400 may include jig plates 420a and 420b to securely mount the stator subassembly 102 onto a jig chuck 410. The jig chuck 410 may be configured to rotate, for example, along direction 411.

During operation, the jig 400 may securely support and rotate the stator subassembly 102 relative to the nozzle(s) 430, which are configured to dispense a potting compound (e.g., an epoxy). The jig 400 may also constrain the pole faces of the pole pieces 170 to maintain sufficient parallel orientation and/or placement to facilitate the formation of air gaps with a desired geometry and/or dimensions.

As the potting compound is trickled out from the nozzle(s) 430, the potting compound may contact and thereafter infiltrate the stator subassembly 102. The infiltration of the potting compound into the stator subassembly 102 may be facilitated, in part, by preheating the stator subassembly 102 to an elevated temperature. For example, the temperature may be equal to about 150° C. That way, as the potting compound physically contacts portions of the stator subassembly 102, the potting compound may be heated, which causes its viscosity to decrease. This, in turn, may allow the potting compound to more readily infiltrate gaps within the stator subassembly 102. The potting compound may physically contact and secure various components of the stator subassembly 102 including, but not limited to, the pole pieces 170 (including the bars 171a or 171b), the support structure assembly 110, the coil assembly 101, and the magnetic pole shoes 186 of the end plates 180.

FIG. 15B shows an example trickle coating system 401 that incorporates one or more jigs 400. As shown, the trickle coating system 401 may include a batch oven configured to continuously process thirty or more stator subassemblies 102. The system 401 may rotate the jigs 400 and/or the stator subassemblies 102 as they travel though various cycles of a trickling epoxy process. For example, the system 401 may first load a new part (e.g., a stator subassembly 102 on a jig 400) at an opening 405. The part may thereafter be transported into a pre-heat oven section 402 where the stator subassembly 102 is heated to an elevated temperature. The part may then be transported to a trickle section 406 where the potting compound is dispensed (e.g., trickled) onto the part from one or more nozzle(s) 430 as the part (e.g., the stator subassembly 102) is rotated. The part is then moved to a final cure oven section 403 to cure the potting compound. Then, the part may be moved through a part cooling section 404 where it is cooled down to a lower temperature where it can be more readily handled. Lastly, the part may be removed from the opening 405.

With this approach, the cost, resources, and time associated with the manufacture and assembly of a stator disclosed herein may be appreciably reduced due to the combination of trickle coating processes being a high-volume process and the stators disclosed herein being easier and faster to manufacture and assemble. Moreover, the various components of the stators disclosed herein may facilitate greater ease of alignment of components during assembly (e.g., components may be readily positioned to within optimal tolerances, such as axial length tolerances), thus reducing manufacturing cycle times and misalignment errors of components.

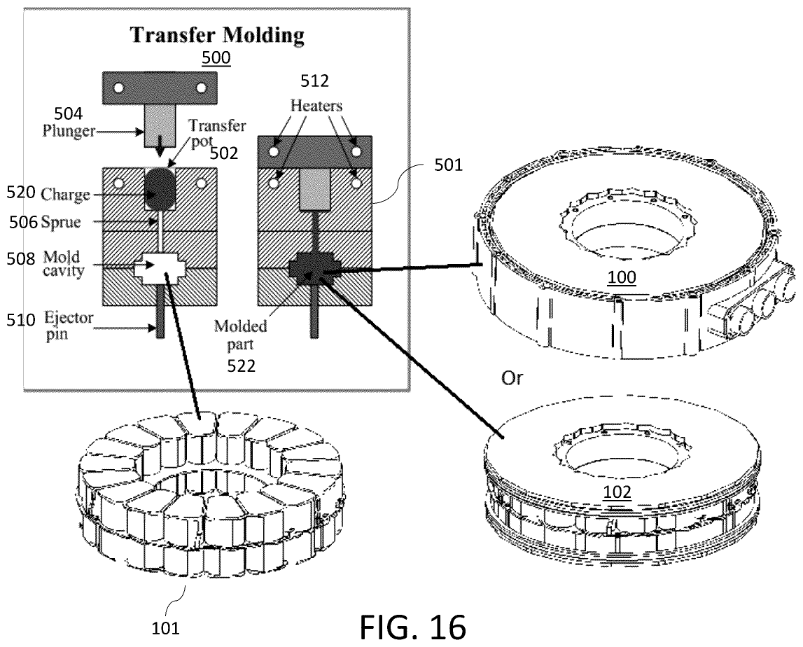

In another example, the potting compound may be introduced using a transfer molding process. FIG. 16 shows an example transfer molding process 500. Before the process 500, the components of the coil assembly 101 may be held together, in part, by the support structure assembly 110. The coil assembly 101 (or, alternatively, the stator subassembly 102 or the stator 100) may be loaded into a transfer mold die 501 where a potting compound (e.g., a plastic or epoxy material) may be injected under pressure to cover and encapsulate at least the coil assembly 101. As shown, the transfer mold die 501 may include a transfer pot 502 to contain a charge 520 (e.g., a charge of potting compound). During injection, a plunger 504 may be pushed into the transfer pot 502, thus displacing the charge 520 through a sprue 506 and into a mold cavity 508. As this occurs, one or more heaters 512 may heat the charge 520 and/or the coil assembly 101 to facilitate infiltration of the potting compound into the coil assembly 101. Once the molded part 522 cools, an ejector pin 510 may facilitate removal of the overmolded coil assembly 101 from the mold 501.

The manner in which the transfer molding process 500 is applied may vary depending on whether the motor is a high-power motor or a low power motor. For example, if the stator 100 with the stator subassembly 102 disposed in the housing 162 is loaded, the potting compound may substantially fill the gaps and/or cavities within the stator 100 in “one shot.” This approach may be suitable for low power motors. In another example, if the stator subassembly 102 is loaded into the mold 501 (i.e., without a housing), the potting compound may partially fill the gaps and/or cavities within the stator 100 but leave portions of the coils exposed. That way, channels (e.g., channels 115) may remain around the coils to facilitate cooling via a liquid coolant. Accordingly, this approach may be suitable for high power motors, especially motors where the coil assembly is directly cooled via a liquid coolant.

It should be appreciated that the transfer molding process 500 may be readily adapted for use in a continuous injection molding process. For example, the transfer pot 502, the charge 520, and the plunger 504 may be replaced by a fluidic circuit coupled to the mold 501 and a source of potting compound. A pump may further be included to drive a continuous flow of potting compound from the source to the mold 501. Once one mold 501 containing a coil assembly 101 is filled, it may then be removed and replaced with another mold 501 containing another coil assembly 101. In this manner, the application of a potting compound in an injection molding process may be relatively faster than a transfer molding process.

### 1.6 Example Methods for Assembly

In one example, a method for assembling a stator comprises: A) assembling a plurality of coils by directly welding at least one end of one coil of the plurality of coils to a corresponding end of another coil of the plurality of coils; B) connecting the plurality of coils to a support structure with one or more traces configured to receive electrical power; C) for each coil of the plurality of coils, inserting a pole piece of a plurality of pole pieces into a first opening defined by that coil; and D) mounting the plurality of pole pieces onto a backplane by inserting respective plug-in portions of each pole piece of the plurality of pole pieces into corresponding second openings of the backplane.

The method may further comprise: E) placing at least the plurality of coils, the plurality of pole pieces, and the support structure into a cavity of a housing; and F) injecting a potting compound into the cavity to surround at least the plurality of coils and the support structure. Alternatively, the method may further comprise: E) placing at least the plurality of coils, the plurality of pole pieces, and the support structure into a transfer mold; F) injecting a potting compound into the transfer mold to surround at least the plurality of coils and the support structure; and G) removing the plurality of coils, the plurality of pole pieces, and the support structure from the transfer mold.

The injection of a potting compound in Step F) for either foregoing process may comprise: loading a predetermined amount of the potting compound into a transfer pot; melting the potting compound in the transfer pot; and transferring the potting compound from the transfer pot to surround at least the plurality of coils and the support structure. Alternatively, the injection of a potting compound in Step F) may comprise: transferring the potting compound from a source providing a continuous supply of molten potting compound to surround at least the plurality of coils and the support structure

### 2. Example Stators with a One-Sided Coil Assembly

It should be appreciated that the stators disclosed herein are not limited to two-sided coil assembly with multiple coil sets formed from a single continuous conductor. Rather, the various inventive concepts and features in the present application may be readily applied to motors with different architectures. Following below are examples of stators and, in particular, stator subassemblies formed using a one-sided coil assembly. The coil assembly may further include multiple coil sets formed from a single continuous conductor or multiple individual coils.

### 2.1 A First Example of a Coil Assembly Formed With a Single Continuous Conductor

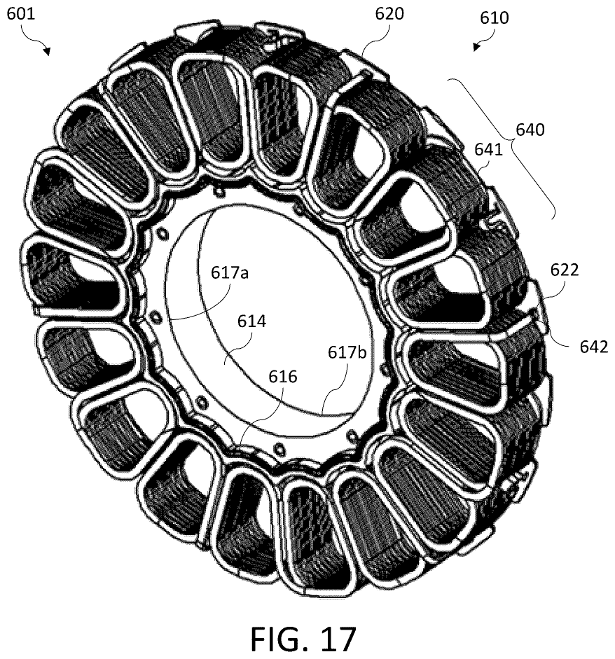

FIG. 17 shows an example one-sided coil assembly 601. As shown, the coil assembly 601 may include multiple features and components from the coil assembly 101. For brevity, a discussion of these features is not repeated below unless indicated otherwise.

As shown, the coil assembly 601 may include a support structure assembly 610 with a coil support hub 614 and a support structure 620 coupled to the coil support hub 614. The coil support hub 614 includes an end 617a and an end 617b opposite to the end 617a. In this example, the support structure 620 may be coupled to the end 617b. In other words, the support structure 620 may be coupled to one end of the coil support hub 614 rather than between the ends 617a and 617b as in the support structure assembly 110.

The coil support hub 614 may include a rib structure (not shown) to facilitate attachment of the coil sets 640 to the support structure assembly 610. In some embodiments, the rib structure may also form one or more flow channels with the coil sets 640. As before, the flow channels may carry liquid coolant to dissipate heat generated by the coil sets 640 during operation. Accordingly, the coil support hub 614 may also support an elastomer seal 616 on each of the ends 617a and 617b to prevent liquid coolant from leaking out of the flow channels.

Multiple coil sets 640 may be mechanically and electrically coupled to the support structure 620. In this example, the coil sets 640 may be disposed on one side of the support structure 620, thus forming a one-sided coil assembly. As a result, the coils 641 may not include any crossover portion or gap. Each coil set 640 may include a pair of ends 642 and each end 642 may be connected to corresponding receptacles 622 on the support structure 620. Each coil set 640 may include multiple coils 641. In some embodiments, the support structure 620 may be configured to receive three electrical power inputs corresponding to the U, V, W phases for a three-phase motor. The support structure 620 may further include multiple traces (not shown) to supply electrical power from the three inputs to corresponding coil sets 640.

In FIG. 17, each coil set 640 may include three coils 641 formed from a single continuous conductor. Thus, the coil set 640 may simplify manufacture and assembly, in part, by reducing the number of welded connections between the coil sets 640 and the support structure 620. Additionally, the coil assembly 601 may not include any busbars since each coil set 640 is directly connected to the support structure 620. Although the coil set 640 is shown as a triplet, it should be appreciated that the coil set 640 may generally include any number of coils as set forth above in the coil set 140. The number of turns in the coils 641 and the type of conductors used may also be the same as set forth for the coils 141. The winding direction of the coils 641 in each coil set 640 may also vary. For example, the coils 641 may have alternating winding directions (e.g., alternating between clockwise and counterclockwise winding directions) as in the coil set 140a. In another example, the coils 641 may have the same winding directions (e.g., all in a counterclockwise winding direction, or all in a clockwise winding direction) as in the coil set 140b.

In some embodiments, the support structure 620 may include multiple voids corresponding to each coil 641 to facilitate, for example, attachment of corresponding pole pieces to the support structure 620. However, it should be appreciated that, in some embodiments, the support structure 620 may not include any voids. Rather, the pole pieces may be disposed in respective openings of each coil 641 and kept in place, for example, by overmolding the coil assembly 601.

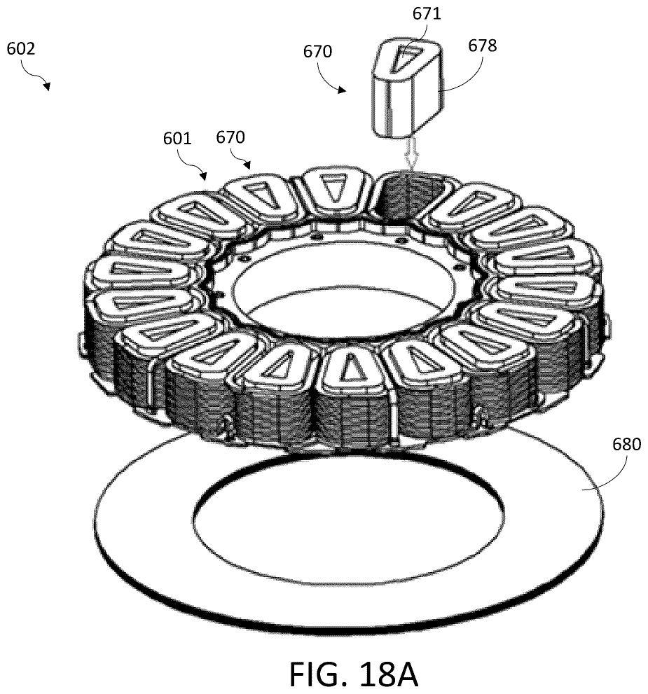

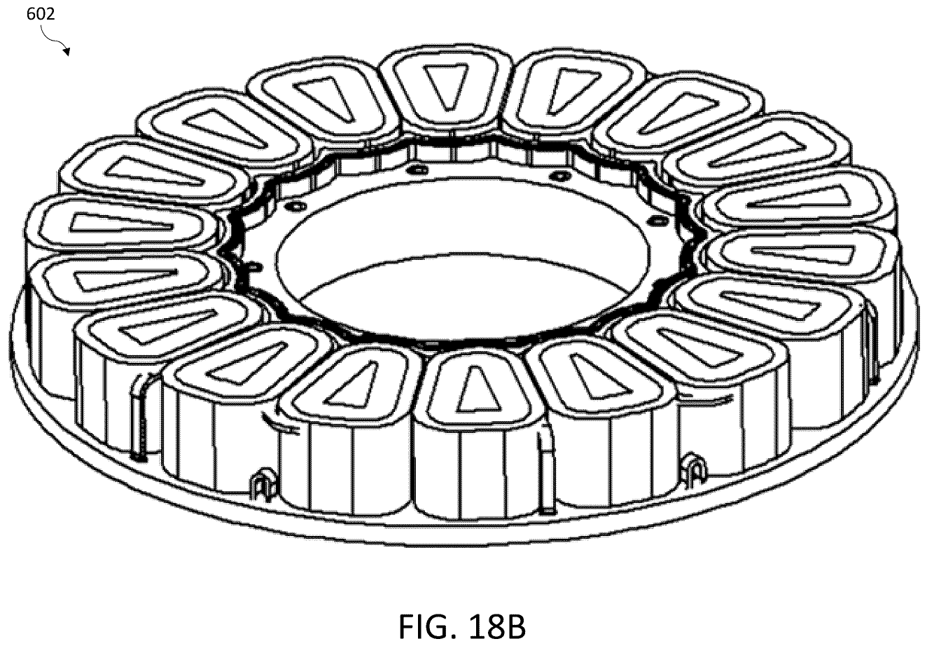

FIG. 18A shows the coil assembly 601 loaded with pole pieces 670. As shown, each pole piece 670 may include a bar 671 surrounded by a wrapping 678. Each pole piece 670 may be inserted into a cavity defined by each coil 641. A stator subassembly 602 may then be formed by mounting the coil assembly 601 to a back iron plate 680. The back iron plate 680 may be formed as a laminated ring. FIG. 18B shows the assembled stator subassembly 602. Once the stator subassembly 602 is assembled, the stator subassembly 602 may then be encapsulated in an electrically insulating material. For example, the stator subassembly 602 may be overmolded with a thermoset plastic. This may be accomplished using, for example, the trickle coating process or the transfer molding process described in Section 1.5.

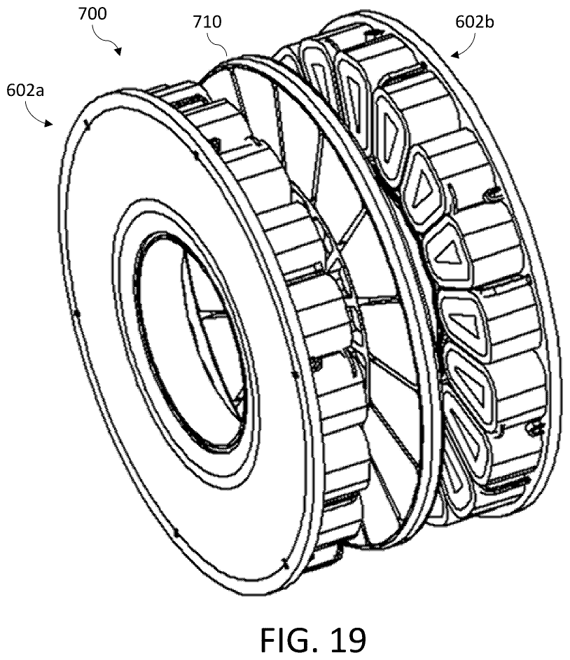

In some embodiments, the stator subassembly 602 may be inserted into a housing (not shown) or may be used without a housing (i.e., the stator subassembly 602 is the stator in this example). In one example, FIG. 19 shows an axial flux motor 700 that incorporates the stator subassembly 602 as a stator (also referred to as an “overmolded stator”). As shown, the motor 700 may include a magnetic rotor 710 with magnets on both sides. The motor 700 may further include a pair of overmolded stators 602a and 602b disposed on opposite sides of the magnetic rotor 710. The magnetic rotor 710 may be securely coupled to a shaft (not shown) and the stators 602a and 602b may be rotatably coupled to the shaft via one or more bearing structures. The motor 700 may further include bell covers, such as the bell covers 320a and 320b in the motor 300.

### 2.2 A Second Example of a Coil Assembly Formed With a Single Continuous Conductor

In the examples above, the coil assemblies include multiple coil sets that are each connected to a support structure. This arrangement reduces the number of welded connections, in part, by eliminating the need to connect each individual coil to a support structure. The number of welded connections may be further reduced by connecting together coil sets configured to receive the same electrical power input (e.g., an input with the same phase).

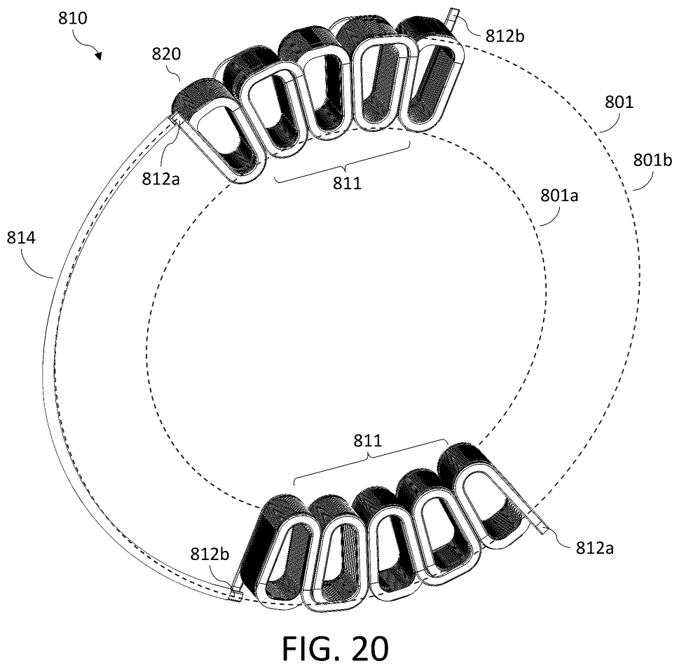

For example, FIG. 20 shows a coil subassembly 810 that includes a pair of coil sets 811 coupled together via a conductor 814 (e.g., a busbar 814). In this example, each coil set 811 may include five coils 820 thus forming a “quintuplet.” However, it should be appreciated the coil set 811 may include any number of coils as set forth above for the coil set 140. The number of turns in the coils 820 and the type of conductors used may also be the same as set forth for the coils 141. The coil set 811 may further be formed from a single continuous conductor. In one example, the coils 820 in each coil set 811 may be formed with alternating winding directions (e.g., alternating between clockwise and counterclockwise winding directions) as in the coil set 140a. In another example, the coils 820 may have the same winding directions (e.g., all in a counterclockwise winding direction, or all in a clockwise winding direction) as in the coil set 140b.

Each coil set 811 may include ends 812a and 812b to facilitate connection to a stator structure (not shown) or another coil set 811 via the conductor 814. As shown in FIG. 20, the end 812a may be disposed on a front side of the coil set 811 and the end 812b may be disposed on a rear side of the coil set 811. The conductor 814 may connect to the end 812a of one coil set 811 and the end 812b of the other coil set 811. This may be accomplished, for example, by welding the respective ends of the conductor 814 to the ends 812a or 812b of the coil set 811. The coil sets 811 may be coplanar, thus the conductor 814 may extend from the front side of one coil set 811 to the rear side of the other coil set 811.

The coil set 811 may be arranged to follow a circular annulus 801 where an inner edge 801a of the annulus 801 is aligned to an inner radial portion of the coils 820 and an outer edge 801b of the annulus 801 is aligned to an outer radial portion of the coils 820. In this example, the ends 812a and 812b may be positioned along the outer edge 801b of the annulus 801.

The conductor 814 may also be curved in shape. For example, the conductor 814 may be curved according to a circular arc following the curvature of the annulus 801 in addition to spanning the front and rear sides of the coil sets 811. In other words, the conductor 814 may have a helical geometry that curves around a circular cylinder at a helix angle sufficient for the conductor 814 to span the front end of one coil set 811 and the rear end of the other coil 811. As shown, the coil sets 811 in the coil subassembly 810 may be diametrically disposed across from one another. With this arrangement, the coil subassembly 810 may be readily nested with other coil subassemblies 810 without interference between the respective coil sets 811 and/or conductors 814 of each coil subassembly 810 (see FIG. 20).

In some embodiments, the coil subassembly 810 may be formed using identical coil sets 811. Thus, the coil subassembly 810 may only include two unique components, i.e., the coil set 811 and the conductor 814. For a three-phase motor, the pair of coil sets 811 in the coil subassembly 810 may constitute respective phase-halves for that phase. Additionally, the same coil subassembly 810 may be used for each electrical power input for the three-phase motor (e.g., for the U, V, and W phases).

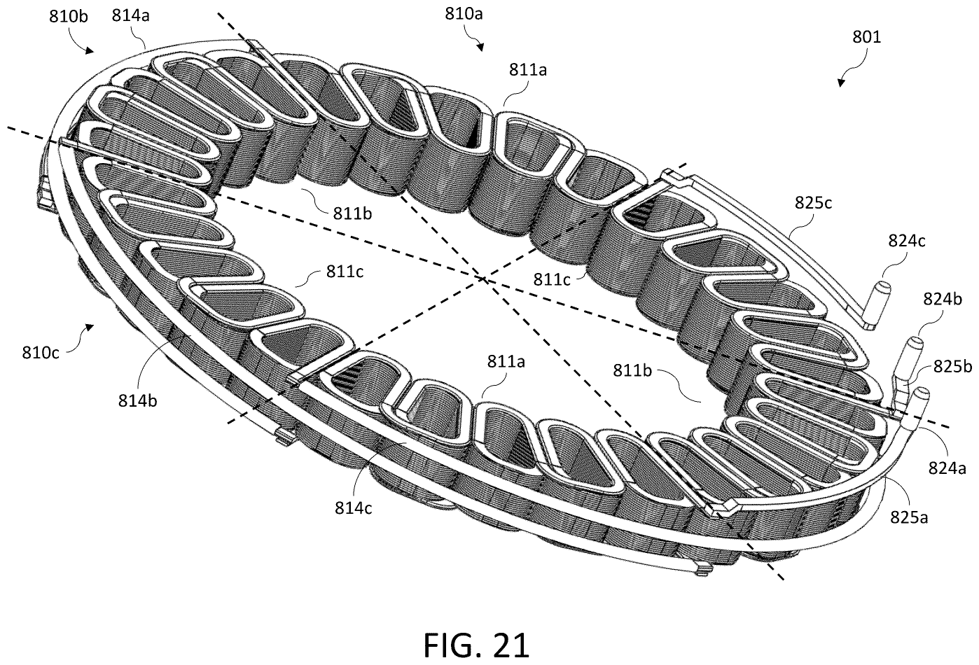

For example, FIG. 21 shows a coil assembly 801 that includes coil subassemblies 810a, 810b, and 810c with respective coil sets 811a, 811b, and 811c and conductors 814a, 814b, and 814c. The coil subassemblies 810a, 810b, and 810c may receive electrical power corresponding to the U, V, and W phases, respectively. As shown, the coil subassemblies 810a, 810b, and 810c may be nested together and rotationally offset from one another by 120 degrees. The coil subassemblies 810a, 810b, and 810c may further be identical to one another. Thus, the coil assembly 801 may only include three conductors to facilitate connections between the coil sets 811a, 811b, and/or 811c. Additionally conductors may be included to facilitate connection to the support structure, as discussed below. This may appreciably simplify the manufacture of the coil assembly 801 because only two unique parts are used in the assembly. The simplicity of the coil assembly 801 may further facilitate manufacture at relatively higher volumes.

FIG. 21 further shows the coil subassembly 810a may be connected at one end to a conductor 825a and a connector 824a to facilitate connection with a connector, for example, on a support structure supplying electrical power for the U phase. The other end of the coil subassembly 810a may be connected to a separate central node (e.g., the central node 208 in the FIG. 7A or the central node 218 in FIG. 7B). Similarly, the coil subassemblies 810b and 810c may be connected to respective conductors 825b and 825c and connectors 824b and 824c at one end to receive electrical power for the V and W phases and a ground connection at another end.

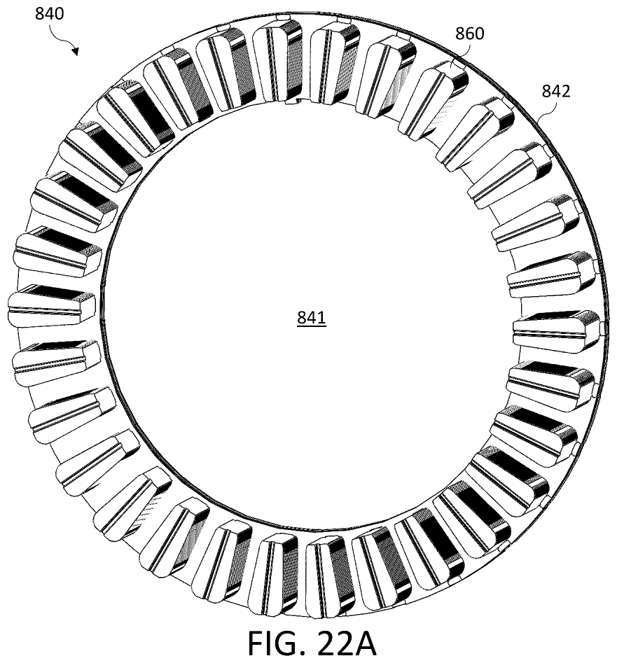

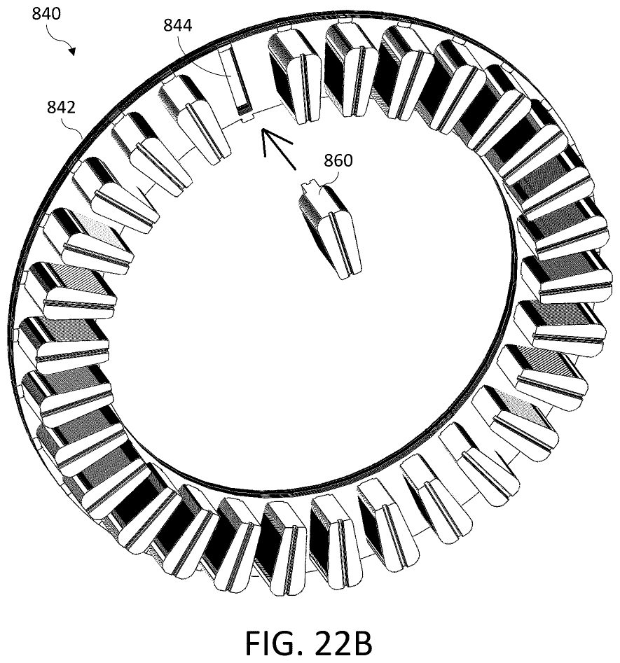

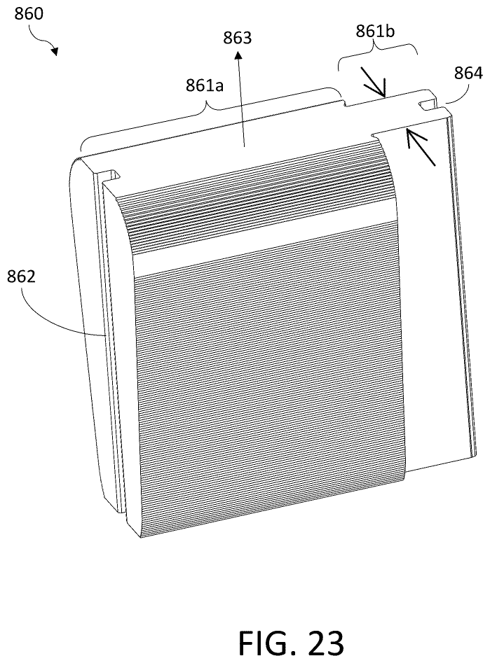

The coil assembly 801 may further be mounted to a backplane assembly with multiple pole pieces. For example, FIGS. 22A and 22B show an example backplane assembly 840 with a backplane 842 and multiple pole pieces 860. The backplane 842 may be annular in shape with a center opening 841. The backplane 842 may further include openings 844 to facilitate attachment of corresponding pole pieces 860 to the backplane 842. In particular, FIG. 23 shows each pole piece 860 may include a bar portion 861a shaped to fill a cavity of a coil 820 and a plug-in portion 861b (also referred to as a “tang portion 861b”) for insertion into the opening 844.

In some embodiments, the manufacturing tolerances for the opening 844 and the plug-in portion 861b of the pole piece 860 may be appreciably tighter than other tolerances in the coil assembly 801 and the backplane assembly 840. In this manner, the pole piece 860 may form a tight fit with the backplane 842 with less or, in some instances, no air gap between the pole piece 860 and the backplane 842. For example, the tolerances for each opening 844 and the plug-in portion 861b of the pole piece 860 may be about ±0.02 mm. The tolerances for the remainder of the backplane 842 and/or the pole piece 860 may be about ±0.1 mm. Thus, the tolerances for each opening 844 and the plug-in portion 861b of the pole piece 860 may be five times smaller than the tolerances for the remainder of the backplane 842 and/or the pole piece 860.

The pole piece 860 may be secured to the backplane 842 in several ways. In one example, the plug-in portion 861b and the opening 844 may have the same shape and be dimensioned to facilitate attachment via a die punch process. Thus, the pole piece 860 may be secured to the backplane 842 via an interference fit. In some embodiments, the shape of the plug-in portion 861b may reduce the number of dimensions relevant for punching to a single dimension (e.g., the width of the plug-in portion 861b as shown by the arrows in FIG. 23). In another example, the plug-in portion 861b and the opening 844 may have the same shape and be dimensioned such that the plug-in portion 861b may be readily inserted into the opening 844 to form a precision fit. Once inserted, the pole piece 860 may be securely coupled to the backplane 842, for example, by welding the pole piece 860 to the backplane 842, or overmolding the stator such that a potting compound holds the pole piece 860 with the backplane 842.

The depth of the openings 844 may be chosen to be always greater than the largest depth of the plug-in portion 861b to ensure the bar portion 861a of the pole piece 860 is able to rest on the backplane 842.

The pole piece 860 may be formed from laminations, such as the laminations 173a or 173b shown in FIGS. 11A and 12B. For example, FIG. 23 shows the pole piece 860 may include laminations stacked along an axis 863. The axis 863 may be parallel to or coincident with a radial axis that intersects the rotation axis 103. The pole piece 860 may further include grooves 862 and 864 formed on respective front and rear sides of the pole piece 860. The grooves 862 and 864 may secure and align the respective laminations (e.g., the laminations 173a or 173b) during manufacture. For example, the grooves 862 and 864 may couple to a die and the laminations may be stacked onto one another via a die stamping process.

The backplane 842 may also be formed from back iron laminations. For example, FIG. 24 shows the backplane 842 may include a laminated structure 845. In some embodiments, the laminated structure 845 may reduce Eddy current losses by more than 90%. The laminated structure 845 may be formed by stacking laminations 846a and 846b in alternating manner along an axis 851. In some embodiments, the axis 851 may be perpendicular to the axis 863 of the pole piece 860. Said another way, the laminations used to form the laminated structure 845 for the backplane 842 may be stacked along an axis perpendicular to the axis along which the laminations for the pole pieces 860 are stacked.

The laminations 846a and 846b are shaped so that no electrical path extends fully around each opening 844 to prevent the generation of undesirable Eddy currents in the backplane 842. The laminations 846a and 846b are further coated with an electrically insulating coating to prevent currents from flowing across multiple laminations.

As shown in FIG. 24, the lamination 846a may include multiple openings 850a corresponding to the locations of the pole pieces 860. Each opening 850a may be offset from an inner edge 848 of the lamination 846a and extend past an outer edge 849 of the lamination 846a. The lamination 846b similarly includes multiple openings 850b corresponding to the locations of the pole pieces 860. In this case, each opening 850b may be offset from the outer edge 849 of the lamination 846b and extend past the inner edge 848 of the lamination 846b. When the laminations 846a and 846b are stacked onto one another in an alternating manner, the openings 850a and 850b may overlap and thus form the opening 844 of the backplane 842. Moreover, in each of the laminations 846a and 846b, Eddy currents cannot flow completely around the respective openings 850a and 850b because there is on continuous electrical path around the openings 850a and 850b.

Eddy current losses may be further reduced by reducing the thickness of the laminations 846a and 846b. For example, the thickness of each of the laminations 846a and 846b may be less than or equal to about 25 μm, about 12.5 μm, or about 5 μm.

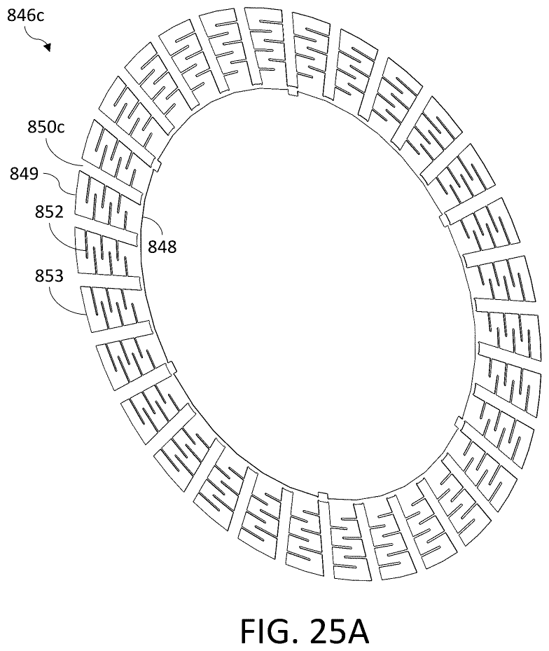

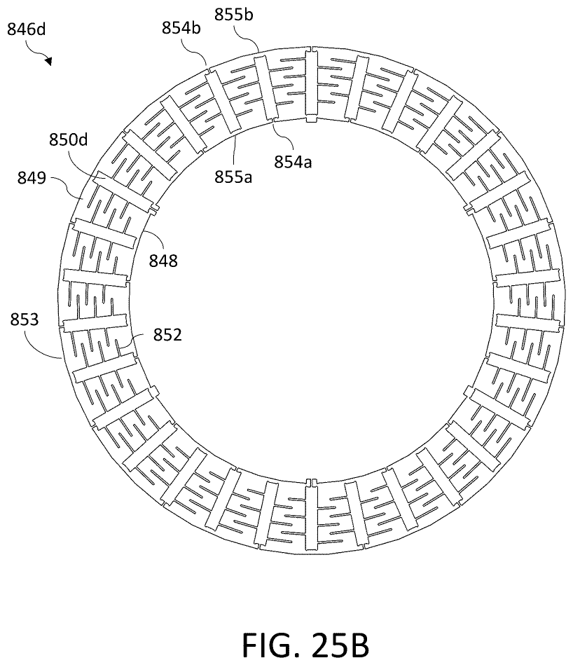

FIG. 25A shows another example lamination 846c that includes multiple openings 850c formed in the same manner as the openings 850a in the lamination 846a. Here, the tabs 853 formed between the openings 850c may be further shaped to have a serpentine geometry. This may be accomplished by the inclusion of additional slits 852 along each tab 853. The geometry of the tabs 853 may further reduce Eddy current losses, in part, by disrupting the flow of any Eddy currents around each opening 850c. It should be appreciated that a similar serpentine design may be adapted for the lamination 846b.

FIG. 25B shows yet another example lamination 846d with multiple openings 850d. In this example, each pair of adjacent openings 850d is separated by a tab 853. Similar to the lamination 846c, each tab 853 may include multiple slits 852 arranged such that the tab 853 forms a serpentine geometry. Additionally, each tab 853 may be connected to another tab 853 via a bridge 855a disposed along an inner edge 848 of the lamination 846d or a bridge 855b disposed along an outer edge 849 of the lamination 846d. As shown in FIG. 25B, the bridges 855a and 855b may alternate along each successive opening 850d around the lamination 846d. To prevent the formation of a closed electrical path around each opening 850d, a slit 854a is included along the inner edge 848 opposite each bridge 855b. Similarly, a slit 854b is included along the outer edge 849 opposite each bridge 855a.

### 2.3 An Example Coil Assembly Formed With Individual Coils

The coil sets disclosed herein may also be assembled by connecting individually formed coils together. Although this may increase the number of welded connections for assembly, the connections may nevertheless be simpler and easier to make since the coils may be connected together separately before being connected to a support structure. Additionally, a coil set assembled from individually formed coils may still provide benefits in terms of reducing the number of welded connections with the support structure and reducing or, in some instances, eliminating busbars from the stator. The manufacture of individual coils is also compatible with conventional coil winding processes.

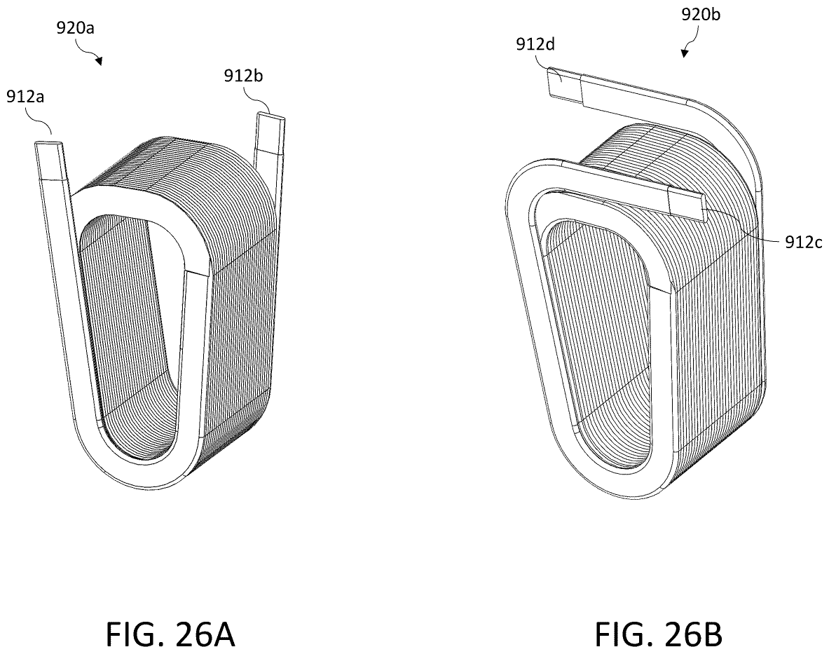

In one example, FIGS. 26A and 26B show coils 920a and 920b, respectively. Specifically, FIG. 26A shows the coil 920a may be formed from a single continuous conductor with exposed ends 912a and 912b. FIG. 26B shows the coil 920b may similarly be formed from a single continuous conductor with exposed ends 912c and 912d. The coils 920a and 920b may be shaped such that the ends 912a and 912b of the coil 920a may be directly connected to either the ends 912c and 912d of the coil 920b and vice-versa. In this manner, the coils 920a and 920b may be directly coupled together without a busbar.

Additionally, the winding direction of the coils 920a and 920b may be readily flipped simply by connecting different ends together. For example, if a coil set with coils having the same winding direction is desired, the coils 920a and 920b may be coupled together by connecting the ends 912b and 912d. In another example, if a coil set with coils having alternating winding direction is desired, the coils 920a and 920b may be coupled together by connecting the ends 912b and 912c. More generally, coil sets may readily be assembled with any desired order of coil winding directions.

Each coil 920a may be directly coupled to a pair of coils 920b, e.g., with one coil 920b connected to the end 912a and the other coil 920b connected to the end 912b. Likewise, each coil 920b may be directly coupled to a pair of coils 920a, e.g., with one coil 920a connected to the end 912c and the other coil 920a connected to the end 912d. As a result, a coil set with an arbitrary number of coils may be formed by coupling together the coils 920a and 920b in an alternating manner. This further means a coil subassembly and a coil assembly may be assembled using only the coils 920a and 920b.

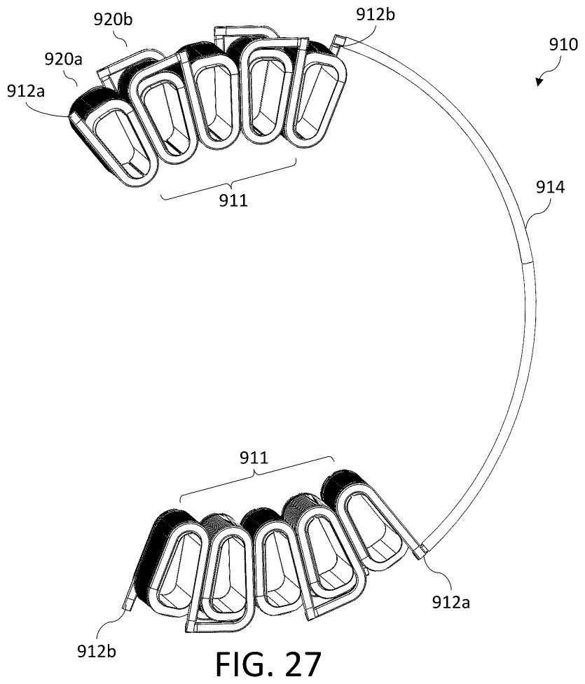

For example, FIG. 27 shows a coil subassembly 910 that includes two coil sets 911 connected together via a conductor 914 (e.g., a busbar 914). The conductor 914 may have the same features as the conductor 814. Each coil set 911 includes five coils formed by connecting coils 920a and 920b in an alternating manner. Thus, the coil set 911 includes three coils 920a and two coils 920b. Further, the pair of coil sets 911 may be identical. Similar to the coil subassembly 810, the conductor 914 may connect to the end 912a of one coil set 911 and the end 912b of another coil set 911. The coil sets 911 may also be disposed diametrically opposite to one another.

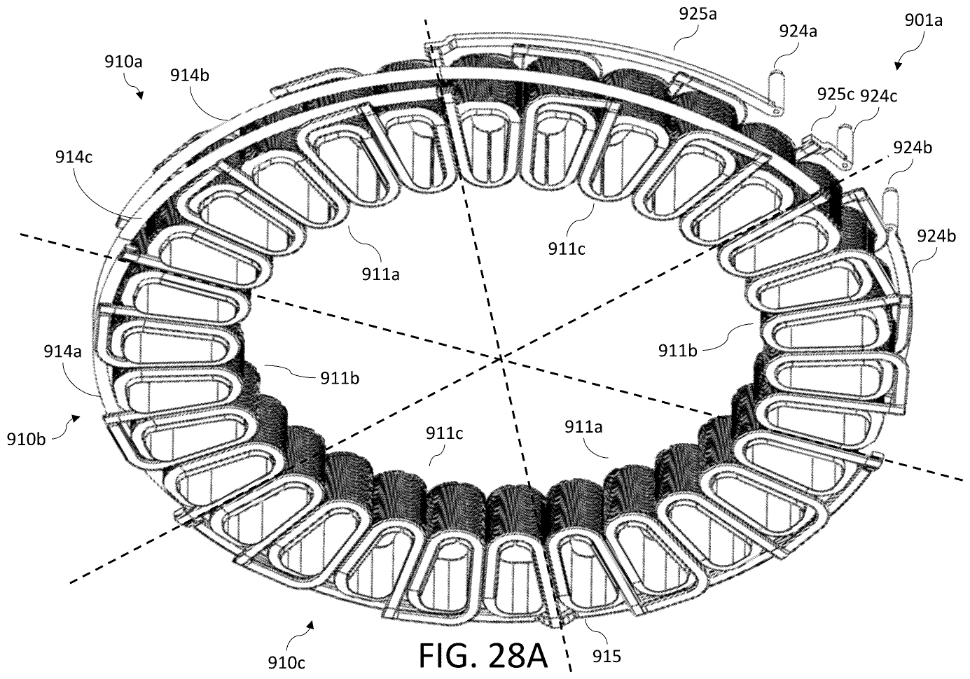

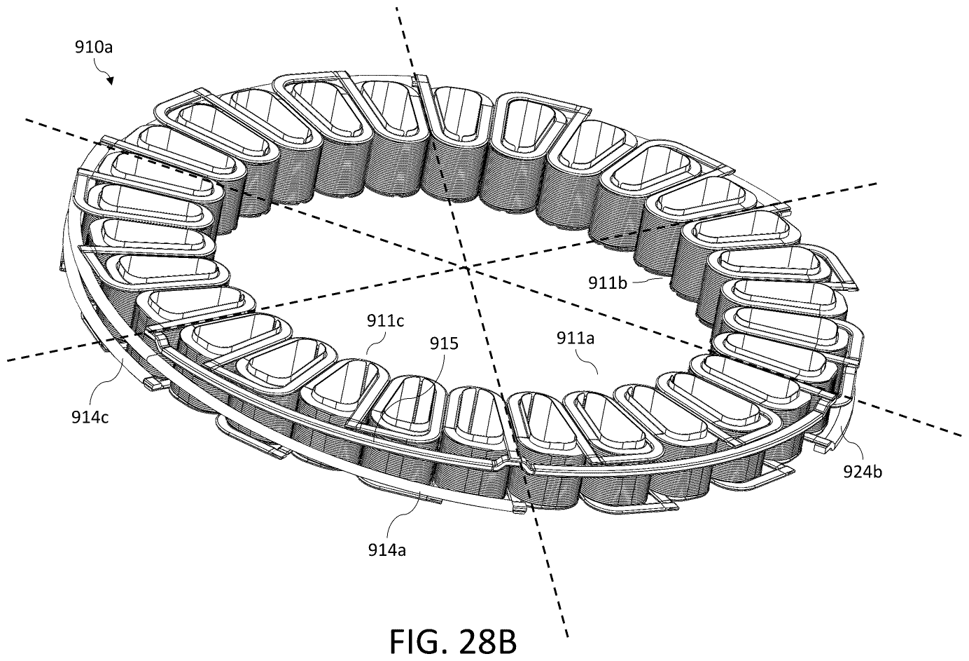

FIGS. 28A and 28B show a coil assembly 901a with three coil subassemblies 910a, 910b, and 910c assembled and nested together. The coil subassemblies 910a, 910b, and 910c may receive electrical power corresponding to the U, V, and W phases for a three-phase motor. The coil subassemblies 910a, 910b, and 910c respectively include coil sets 911a, 911b, and 911c and conductors 914a, 914b, and 914c. Additionally, the coil subassemblies 910a, 910b, and 910c may each be connected at one end to respective conductors 925a, 925b, and 925c and connectors 924a, 924b, and 924c, which supply electrical power corresponding to the U, V, and W phases.

The other end of respective coil subassemblies 910a, 910b, and 910c may be connected to a central node (e.g., the central node 208 in the FIG. 7A or the central node 218 in FIG. 7B) via a conductor 915. Similar to the coil subassembly 810, the coil subassembly 910 may be designed such that ends 912a, 912b, 912c, and 912d are disposed along an outer radial portion of the subassembly 910 (i.e., an outer edge of an annulus as in FIG. 20). This arrangement may be preferable, for example, to facilitate connection of the stator to a separate inverter. However, it should be appreciated that this arrangement is non-limiting.

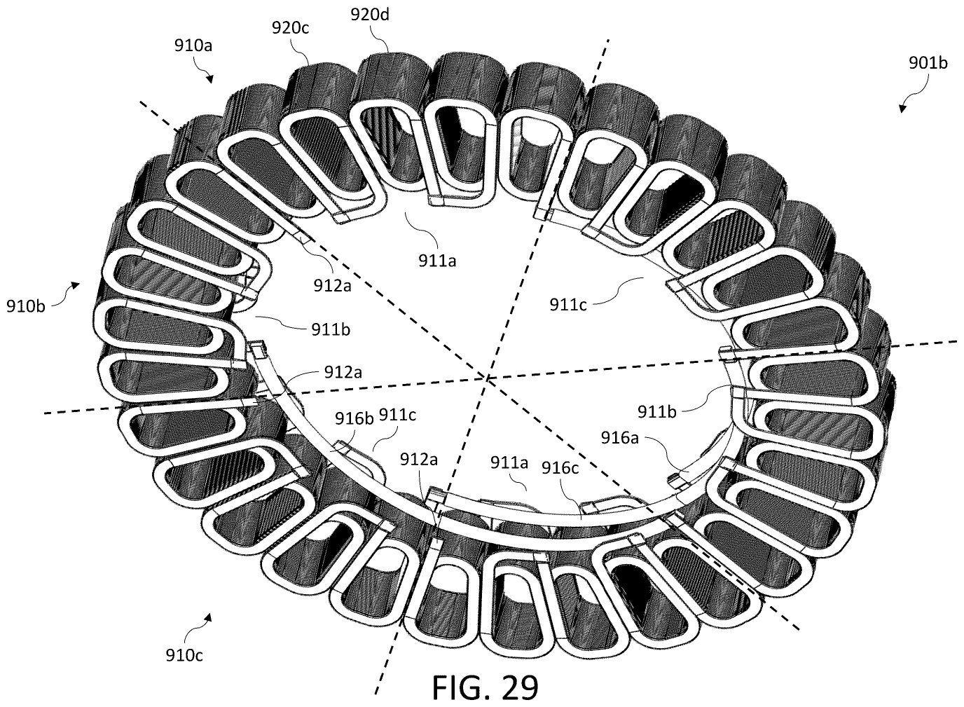

For example, FIG. 29 shows a coil assembly 901b with three coil subassemblies 910a, 910b, and 910c assembled from coils 920c and 920d. As shown, the respective ends 912a, 912b, 912c, and 912d of the coils 920c and 920d are disposed along an inner radial portion of the coil assembly 901b (i.e., an inner edge of an annulus as in FIG. 20). The respective coil sets 911a in the coil subassembly 910a may thus be connected together via a conductors 916a. Similarly, conductors 916b and 916c may connect respective coil sets 911b and 911c in the coil subassemblies 910b and 910c. As shown, the conductors 916a, 916b, and 916c may be disposed in an interior portion of the coil assembly 901b. This arrangement may be preferable in applications where an inverter is located at least partially inside the stator.

### 3. Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A stator for an electric motor, the stator comprising:
a hub defining a rotation axis;
a support structure, directly coupled to the hub, having one or more traces configured to receive electrical power; and
a plurality of coils, electrically coupled to the support structure, to generate one or more magnetic fields from the electrical power,
wherein each coil of the plurality of coils is directly coupled in series to at least one other coil of the plurality of coils.

2. (canceled)

3. The stator of claim 1, wherein:
each coil of the plurality of coils comprises:
an electrical conductor having a first end and a second end,
wherein at least one of the first end or the second end is directly welded to a corresponding first end or a corresponding second end of another coil of the plurality of coils; and
the plurality of coils comprises:
a subset of coils connected in series.

4-11. (canceled)

12. The stator of claim 3, wherein:
the subset of coils comprises:
a first group of coils, each coil in the first group of coils being adjacent and directly welded to at least one other coil of the first group of coils;
the electrical conductor of respective coils of the plurality of coils is a first electrical conductor; and
the subset of coils further comprises:
a second group of coils, each coil of the second group of coils being adjacent and directly welded to at least one other coil of the second group of coils; and
a second electrical conductor, electrically coupled to one coil of the first group of coils and one coil of the second group of coils, to electrically connect in series the first group of coils to the second group of coils.

13. (canceled)

14. The stator of claim 12, wherein:
the first group of coils is coplanar with the second group of coils;
the second electrical conductor is directly coupled to a front side of the first group of coils and a back side of the second group of coils; and
the second electrical conductor is curved in shape.

15. The stator of claim 12, wherein:
the first and second groups of coils are arranged along a circular annulus centered about the rotation axis; and
the first group of coils is disposed diametrically opposite to the second group of coils.

16. The stator of claim 12, wherein the second electrical conductor is disposed along an inner radial portion of the subset of coils.

17. The stator of claim 12, wherein the second electrical conductor is disposed along an outer radial portion of the subset of coils.

18. The stator of claim 3, wherein:
the electric motor is a three-phase electric motor; and
the subset of coils receives electrical power from a trace of the one or more traces of the support structure, the electrical power corresponding to one of a U phase, a V phase, or a W phase.

19. The stator of claim 18, wherein:
the trace is a first trace;
the subset of coils is a first subset of coils that receives the electrical power from the first trace corresponding to the U phase; and
the plurality of coils further comprises:
a second subset of coils connected in series and receiving electrical power from a second trace of the one or more traces of the support structure, the electrical power from the second trace corresponding to the V phase; and
a third subset of coils connected in series and receiving electrical power from a third trace of the one or more traces of the support structure, the electrical power from the third trace corresponding to the W phase.

20. The stator of claim 19, wherein the first, the second, and the third subsets of coils are arranged along a circular annulus centered about the rotation axis.

21. (canceled)

22. (canceled)

23. The stator of claim 19, wherein:
the electrical conductor of respective coils of the plurality of coils is a first electrical conductor; and
each of the first, the second, and the third subsets of coils comprises:
a first group of coils, each coil of the first group of coils being adjacent and directly welded to at least one other coil of the first group of coils;
a second group of coils, each coil of the second group of coils being adjacent and directly welded to at least one other coil of the second group of coils; and
a second electrical conductor, electrically coupled to one coil of the first group of coils and one coil of the second group of coils, to electrically connect in series the first group of coils to the second group of coils.

30. (canceled)

31. The stator of claim 1, wherein:
each coil of the plurality of coils surrounds an opening; and
the stator further comprising:
a plurality of pole pieces, each pole piece of the plurality of pole pieces being disposed in a corresponding opening of one coil of the plurality of coils.

32. The stator of claim 31, wherein each pole piece of the plurality of pole pieces is a laminated pole piece comprising:
a plurality of laminations bonded and stacked onto one another along an axis, the axis being parallel to a radial axis of the stator.

33. (canceled)

34. (canceled)

35. The stator of claim 31, further comprising:
a plurality of bobbins, each bobbin of the plurality of bobbins being formed from an electrical insulator and disposed around one pole piece of the plurality of pole pieces to separate that pole piece from a corresponding coil of the plurality of coils.

36. The stator of claim 31, further comprising:
a backplane having a plurality of openings,
wherein each pole piece of the plurality of pole pieces has a plug-in portion that is inserted into a corresponding opening of the plurality of openings such that the backplane mechanically supports the that pole piece.

37. (canceled)

38. The stator of claim 36, wherein:
the backplane is formed from a plurality of laminations, the plurality of laminations comprising at least a first lamination and a second lamination directly bonded to the first lamination; and
the first and second laminations being shaped such that the backplane does not provide an electrical path spanning a periphery of each opening of the plurality of openings.

39. The stator of claim 38, wherein:
the plurality of laminations is a first plurality of laminations stacked along a first axis; and
each pole piece of the plurality of pole pieces is a laminated pole piece comprising:
a second plurality of laminations bonded and stacked along a second axis, the second axis being perpendicular to the first axis.

43. (canceled)

44. An axial flux motor, comprising:
a shaft;
a magnetic rotor coupled to the shaft and rotatable about the rotation axis;
a first stator disposed on a first side of the magnetic rotor and rotatably coupled to the shaft; and
a second stator disposed on a second side of the magnetic rotor opposite the first side and rotatably coupled to the shaft,
wherein:
each of the first and second stators is identical to the stator of claim 1; and
for each of the first and second stators:
the hub has a first end and a second end;
the support structure is disposed on the hub at one of the first end or the second end; and
the plurality of coils is disposed on only one side of the support structure.

45. (canceled)

46. (canceled)

47. An axial flux motor, comprising:
a shaft;
the stator of claim 1 rotatably coupled to the shaft;
a first magnetic rotor coupled to the shaft and rotatable about the rotation axis, the first magnetic rotor being disposed on a first side of the stator; and
a second magnetic rotor coupled to the shaft and rotatable about the rotation axis, the second magnetic rotor being disposed on a second side of the stator opposite the first side,
wherein:
the hub of the stator has a first end and a second end;
the support structure of the stator is disposed on the hub between the first end and the second end;
the plurality of coils of the stator is disposed on two opposing sides of the support structure; and
each coil of the plurality of coils comprises:
a first portion disposed on a first side of the support structure;
a second portion disposed on a second side of the support structure opposite the first side; and
a crossover portion to engage the support structure and connect the first portion to the second portion.

48. A stator for a three-phase axial flux motor, the stator comprising:
a hub defining a rotation axis and having a first end and a second end;
a support structure, directly coupled to the first end of the hub, having one or more traces configured to receive electrical power corresponding to one of a U phase, a V phase, or a W phase; and
a first plurality of coils, disposed on a side of the support structure and electrically coupled to the support structure, to generate one or more magnetic fields from the electrical power corresponding to the U phase;
a second plurality of coils, disposed on the side of the support structure and electrically coupled to the support structure, to generate one or more magnetic fields from the electrical power corresponding to the V phase;
a third plurality of coils, disposed on the side of the support structure and electrically coupled to the support structure, to generate one or more magnetic fields from the electrical power corresponding to the W phase,
wherein:
each of the first, the second, and the third pluralities of coils comprises:
a first group of coils, each coil of the first group of coils being adjacent and directly welded to at least one other coil of the first group of coils;
a second group of coils, each coil of the second group of coils being adjacent and directly welded to at least one other coil of the second group of coils; and
an electrical conductor, electrically coupled to one coil of the first group of coils and one coil of the second group of coils, to electrically connect in series the first group of coils to the second group of coils; and
the first, the second, and the third pluralities of coils are nested together and arranged to fully span a circular annulus.

58. (canceled)
